(19) United States
(12) Patent Application Publication
(10) Pub. No.: US 2007/0290084 A1
(43) Pub. Date: Dec. 20, 2007

(54) Kitchen Garbage Disposing Apparatus

(75) Inventors: Yoshitaka Ootsuka, Gunma (JP); Atsushi Matsuoka, Gunma (JP)

Correspondence Address: SMITH-HILL AND BEDELL, P.C., 16100 NW CORNELL ROAD, SUITE 220, BEAVERTON, OR, 97006, US

(73) Assignee: MAX CO. LTD., Tokyo (JP)

(21) Appl. No.: 11/718,666

(22) PCT Filed: Nov. 8, 2005
(86) PCT No.: PCT/JP05/20467

§ 371 Date: May 4, 2007

(30) Foreign Application Priority Data
Nov. 12, 2004 (JP) 2004-329398

(51) Int. Cl. B02C 18/00

(52) U.S. Cl. 241/36

(57) ABSTRACT

A garbage disposal is prevented from being driven continuously in a condition where it is overloaded. A control section monitors a current value signal output from the current detection circuit that detects a current flowing through a motor and controls the motor to revolve inversely, if having detected a current not less than a predetermined overcurrent detection threshold value when a period of time when the overcurrent is detected reaches a predetermined period of overcurrent detection setting time. If the number of times of reverse revolution of the motor based on the overcurrent detection reaches a predetermined number of times of the reverse revolution, the motor stops.

### TECHNICAL FIELD

The present invention relates to a garbage disposal that crushes garbage which occurs in a kitchen etc. and, more specifically, a garbage disposal that improves durability by preventing it from being driven continuously in a condition where it is overloaded.

### BACKGROUND ART

On the garbage disposal to crush and dispose garbage which occurs in general households, restaurants, etc., garbage disposals of two types, that is, a hammer mill type and a grinder type are known. The garbage disposal of hammer mill type has a fixed hammer or a slidable hammer on a disk arranged at a bottom of a cylindrical hopper (see, for example, Japanese Patent Application Publication No. 2001-70818).

In the garbage disposal of hammer mill type, garbage thrown into a hopper is pressed against an inner circumferential surface of the hopper by centrifugal force that occurs due to a revolution of the disk driven by a motor and crushed by the hammer. Then, it runs downward through grooves formed in a wall surface of the hopper or a gap between an outer edge of the disk and the inner circumferential surface of the hopper and then, runs into a drain pipe.

The garbage disposal of grinder type has such a configuration that a crushing rotary blade and a crushing fixed blade, each of which has comb-tooth shaped blades arranged radially, are laminated alternately and contained in the hopper (see, for example, Japanese Patent Application Publication (Kohyo) No. 2002-521193).

In the garbage disposal of grinder type, the respective comb-tooth shaped blades of the laminated crushing rotary blade and crushing fixed blade are engaged with each other with small spacing held between them, so that by revolving the crushing rotary blade with water power, the comb-tooth shaped blades of the respective crushing rotary blade and crushing fixed blade crush the garbage with the garbage being gripped.

Well, for the garbage disposal of hammer mill type, a technology has been proposed to drive a motor inversely if it is detected that the motor is locked in its revolution because a hammer has jammed the garbage etc. (see, for example, Japanese Patent Application Publication No. Hei 8-24700).

### DISCLOSURE OF THE INVENTION

However, in the conventional garbage disposals, such a problem that the motor is being driven continuously with it being overloaded, thus resulting in burn-out of the motor etc., has issued because the motor continues to be driven until it is locked completely.

The present invention has been developed to solve such the problem and it is an object of the present invention to provide a garbage disposal that can prevent the disposal from being driven continuously even in a condition where it is overloaded.

In order to accomplish the object, the invention claimed in claim 1 is a garbage disposal containing crushing means that crushes an object to be crushed which is thrown into a throwing opening formed in a sink and drive means that rotationally drives the crushing means, characterized in that the garbage disposal comprises current detection means that detects a current flowing through the drive means, and control means that monitors an output of the current detection means to decide whether or not an overcurrent is flowing and controls the drive means to revolve inversely, if having detected a current not less than a predetermined overcurrent detection threshold value.

The invention claimed in claim 2 is characterized in that in the garbage disposal according to claim 1, when driving of the drive means has started, the control means monitors the output of the current detection means to decide whether the overcurrent is flowing after a predetermined standby time elapses.

The invention claimed in claim 3 is characterized in that in the garbage disposal according to claim 1 or 2, the control means integrates detected current values as many as a predetermined number of times of reading after having detected a current not less than the overcurrent detection threshold value and, if an average value of the integrated ones is not less than the overcurrent detection threshold value, the control means controls the drive means to revolve inversely.

The invention claimed in claim 4 is characterized in that in the garbage disposal according to claim 1, 2 or 3, the control means controls the drive means to revolve inversely if a period of time when a current not less than the overcurrent detection threshold value is detected reaches a predetermined period of overcurrent detection setting time.

The invention claimed in claim 5 is characterized in that in the garbage disposal according to claim 4, if having detected no current equal to or larger than the overcurrent detection threshold value, the control means controls the drive means to revolve inversely for every constant period of time larger than the period of overcurrent detection setting time.

The invention claimed in claim 6 is characterized in that in the garbage disposal according to claim 1, 2, 3, 4, or 5, the control means counts the number of times of reverse revolution of the drive means based on the overcurrent detection and stops driving of the drive means if the number of times reaches a predetermined number of times of the reverse revolution.

The invention claimed in claim 7 is characterized in that in the garbage disposal according to claim 6, if the number of times of reverse revolution of the drive means based on the overcurrent detection reaches a predetermined number of times of reverse revolution, the control means stops driving of the drive means after conducting reverse revolution control for a short period of time.

The invention claimed in claim 8 is characterized in that in the garbage disposal according to claim 1, 2, 3, 4, 5, 6, or 7, the crushing means contains a crushing rotary blade and a crushing fixed blade, which are put one upon another alternatively below the throwing opening, and the crushing rotary blade is driven rotationally by the drive means to crush an object to be crushed between the crushing rotary blade and the crushing fixed blade and run the object downward.

According to the present invention, by deciding whether an overcurrent is flowing through the drive means that rotationally drives crushing means, it is possible to detect that the crushing means is overloaded because it cannot normally revolve due to, for example, jamming of a hard object which is crushed or cannot be crushed, before the drive means is locked completely.

Then, if the overcurrent is detected, the drive means is controlled to revolve inversely and hence the revolution direction of crushing means is reversed, thereby eliminating overload causes such as jamming of crushed objects.

It is thus possible to provide a garbage disposal with improved durability because it can be prevented the crushing means and the drive means from being driven in a condition where they are overloaded so that they may not be burnt out.

### BRIEF DESCRIPTION OF THE DRAWINGS

FIG. 1 is a functional block diagram for showing one example of a configuration of a control system for a garbage disposal of the present embodiment;

FIG. 2 is a configuration diagram for showing one example of the garbage disposal of the present embodiment;

FIG. 3 is a configuration diagram for showing one example of a cap switch;

FIG. 4 is a front cross-sectional view of a crushing unit constituting the garbage disposal;

FIG. 5 is a perspective view of an exploded important portion of the crushing unit constituting the garbage disposal;

FIG. 6A is a flowchart for showing an example of processing when a cap body is closed (Example 1);

FIG. 6B is a flowchart for showing another example of processing when the cap body is closed (Example 2);

FIG. 7A is an explanatory illustration for illustrating operations to close the cap body;

FIG. 7B is another explanatory illustration for illustrating the operations to close the cap body;

FIG. 7C is further explanatory illustration for illustrating the operations to close the cap body;

FIG. 8 is a timing chart for showing output patterns of a first cap switch and a second cap switch when the cap body is closed;

FIG. 9 is a flowchart for showing an example of processing to decide whether the cap body is open or closed;

FIG. 10A is a timing chart for showing an interruption timing at which reading of output patterns of the first and second cap switches happens;

FIG. 10B is a timing chart for showing output patterns of the first and second cap switches caused by opening and closing the cap bodies;

FIG. 10C is another timing chart for showing the output patterns of the first and second cap switches caused by opening and closing the cap bodies;

FIG. 11 is a flowchart for showing an example of overall processing of motor drive control;

FIG. 12 is a flowchart for showing an example of software processing of motor revolution control;

FIG. 13 is a timing chart for the motor drive control at the time of normal operations;

FIG. 14 is a timing chart for the motor drive control at the time of overcurrent;

FIG. 15 is a flowchart for showing an example of software processing of the motor control at the time of the overcurrent;

FIG. 16 is a flowchart for showing another example of the software processing of the motor control at the time of the overcurrent;

FIG. 17 is a flowchart for showing further example of the software processing of the motor control at the time of the overcurrent;

FIG. 18A is a waveform chart for showing an interruption timing at which a current flowing through the motor is read;

FIG. 18B is a waveform chart of a current flowing through the motor;

FIG. 19 is a timing chart in a case where the overcurrent is detected by software normally;

FIG. 20 is a timing chart in a case where no overcurrent is detected by software normally, but the overcurrent is successfully detected by a hardware timer;

FIG. 21A is a timing chart for showing the motor control by means of opening/closing of the cap body and overcurrent detection;

FIG. 21B is another timing chart for showing the motor control by means of the opening/closing of the cap body and overcurrent detection; and

FIG. 21C is further timing chart for showing the motor control by means of the opening/closing of the cap body and overcurrent detection.

### BEST MODE FOR CARRYING OUT THE INVENTION

The following will describe embodiments of a garbage disposal according to the invention with reference to drawings.

<Example of Outlined Configuration of Garbage Disposal>

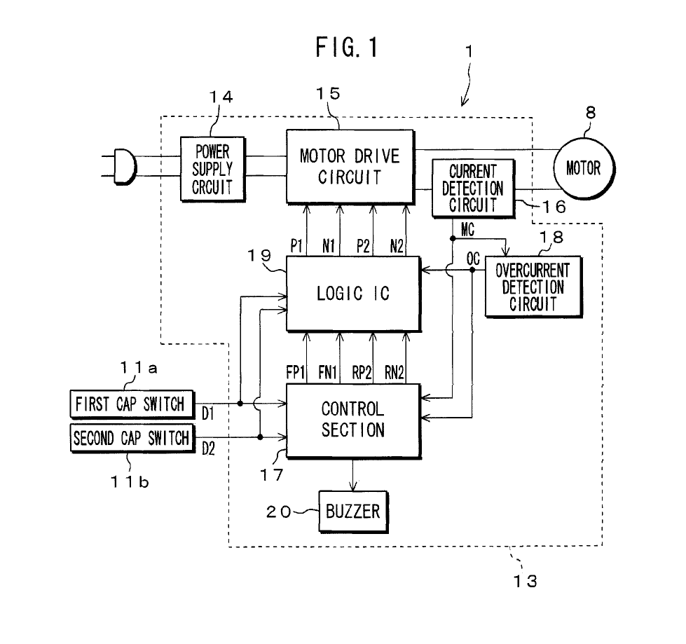

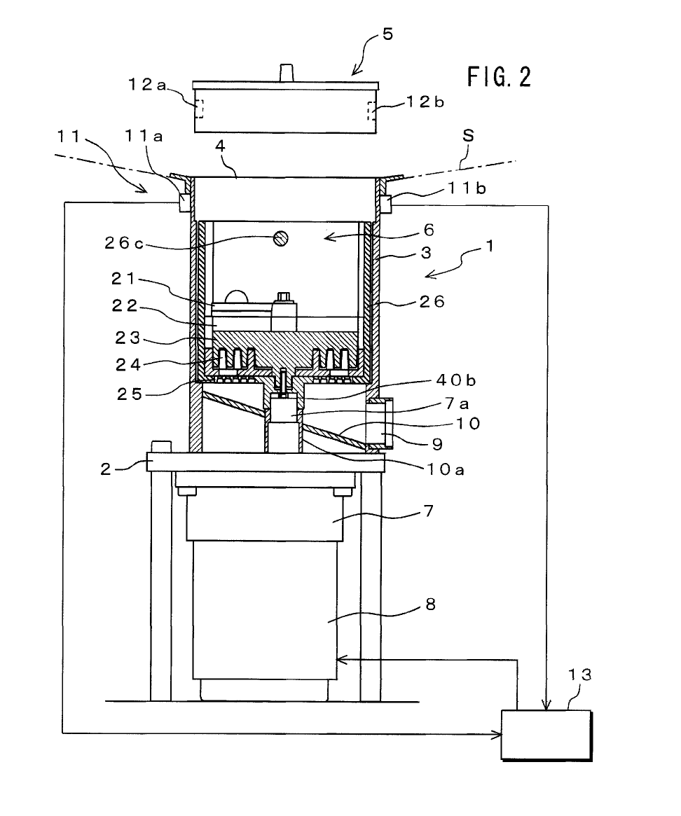

FIG. 1 is a functional block diagram for showing one example of a configuration of a control system for a garbage disposal of the present embodiment, and FIG. 2 is a configuration diagram for showing one example of the garbage disposal of the present embodiment. First, a configuration of the garbage disposal 1 of the present embodiment will be described with reference to FIG. 2. Note that FIG. 2 schematically shows characteristics of the garbage disposal 1. The garbage disposal 1 is referred to as a grinder type one, and is installed, for example, on any kitchen facilities, as well as a hopper 3 into which garbage and the like are thrown is mounted on a base frame 2 so that an upper end of the hopper 3 may fit to an opening in a kitchen sink S.

The hopper 3 is an upright cylindrical part, whose upper end is open to form a throwing opening 4 to which a cap body 5 is attached detachably. The throwing opening 4 and the cap body 5 are equipped with an attaching/detaching mechanism that locks and unlocks under a closed condition of the cap body 5, by turning operation of the cap body 5 that has been attached into the throwing opening 4.

For example, if the cap body 5 is attached into the throwing opening 4 and turned by a predetermined angle in a direction, a rib or the like, not shown, of the cap body 5 is caught, so that the cap body 5 is locked under its closed condition with it being attached into the throwing opening 4.

Further, if the locked cap body is turned by a predetermined angle in the other direction, the rib or the like is released so that the cap body 5 is unlocked under its closed condition, and then, the cap body 5 now can be detachably attached into the throwing opening 4.

Inside of the hopper 3, a crushing unit 6 is detachably contained into the hopper 3. The crushing unit 6 is equipped with a crushing rotary blade and a crushing fixed blade, which will be described later, to constitute crushing means, in such a configuration that the crushing rotary blade may fit to a drive shaft 7a of a decelerating unit 7 and a motor 8 attached to the base frame 2 may rotationally drive the crushing rotary blade of the crushing unit 6 via the decelerating unit 7. Although not shown in detail, in the drive shaft 7a for transmitting any drive force to the crushing unit 6, a portion thereof that fits to the crushing unit 6 is formed as a square shaft, a spline shaft or the like. The motor 8 constitutes drive means and, in the present example, a DC motor is utilized.

At a lower part of the hopper 3, a bottom plate 10 is provided which is inclined toward a drain connection opening 9 formed in an outer circumference of the hopper 3, and at a center of the bottom plate 10, a shaft hole 10a is formed through which the drive shaft 7a of the decelerating unit 7 passes.

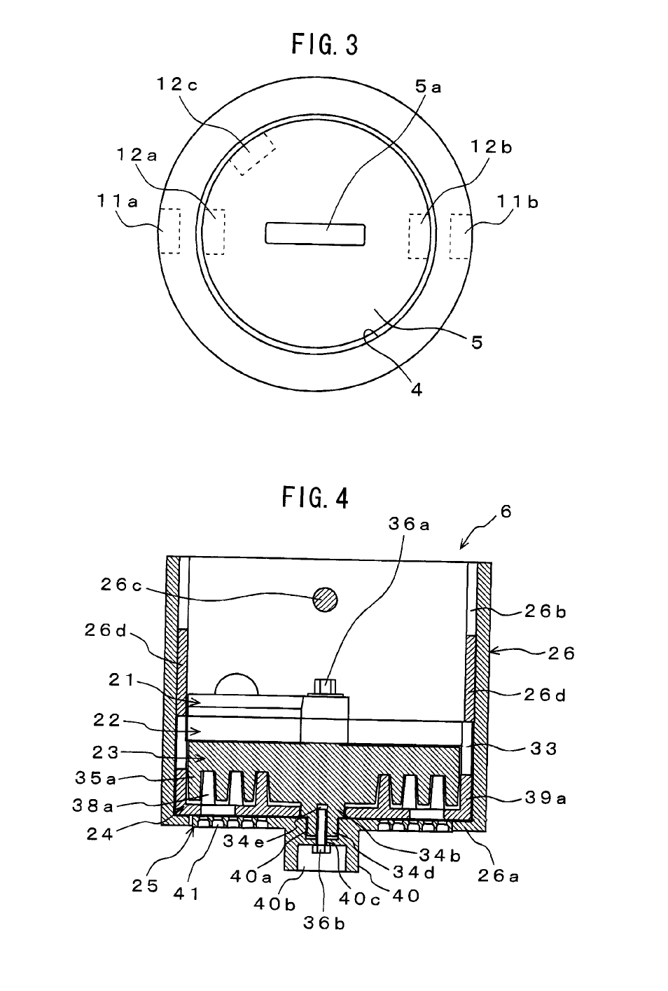

The garbage disposal 1 is equipped with a cap switch 11 that outputs an OPEN/CLOSE signal in response to opening/closing of the cap body 5. FIG. 3 is a configuration diagram for showing one example of the cap switch 11, in which outlines of the throwing opening 4 and the cap body 5 are shown as a plan view thereof.

The cap switch 11 constitutes cap body detection means, having a first cap body switch 11a and a second cap body switch 11b around the throwing opening 4, and a first magnet 12a, a second magnet 12b, and a third magnet 12c in the cap body 5.

The first cap switch 11a and the second cap switch 11b are each constituted of a proximity sensor and arranged so that they can face each other across the throwing opening 4 with angular spacing of 180 degrees held between them. The first magnet 12a and the second magnet 12b are arranged inside an outer circumference of the cap body 5 with angular spacing of 180 degrees held between them. The third magnet 12c is arranged inside the outer circumference of the cap body 5 with predetermined angular spacing from the first magnet 12a.

It is configured that, at a position where the cap body 5 can be detachably attached to the throwing opening 4, the third magnet 12c faces the first cap switch 11a, and if a handle 5a is manipulated to turn the cap body 5 to its locked position under its closed condition, as shown in FIG. 3, the first magnet 12a faces the first cap switch 11a and the second magnet 12b faces the second cap switch 11b.

Accordingly, the cap body 5 is attached to the throwing opening 4 and locked under its closed condition, whereupon the first cap switch 11a and the second cap switch 11b are both turned, for example, ON to output the OPEN/CLOSE signal indicating that the cap body 5 is closed.

On the other hand, in a condition where the cap body 5 is not attached to the throwing opening 4 and open, the first cap switch 11a and the second cap switch 11b are both turned, for example, OFF to output the OPEN/CLOSE signal indicating that the cap body 5 is open.

Referring back to FIG. 2, the garbage disposal 1 is also equipped with a control unit 13 that controls revolution driving of the motor 8. The control unit 13 controls start, stop, etc. of revolution of the motor 8 in accordance with the output of the cap switch 11 and the like.

<Example of Control Functions of Garbage Disposal>

Next, a configuration of the control system of the garbage disposal 1 of the present embodiment will be described below with reference to FIG. 1. The control unit 13 is equipped with a power supply circuit 14 for supplying power, a motor drive circuit 15 for driving the motor 8 shown in FIG. 2 etc., and a current detection circuit 16 for detecting a current flowing through the motor 8.

It is further equipped with a control section 17 that is connected to the first cap switch 11a and the second cap switch 11b shown in FIG. 2 etc. to control driving of the motor 8 in accordance with opening and closing of the cap body 5 and the like.

Further, it is equipped also with an overcurrent detection circuit 18 for detecting that an overcurrent is flowing through the motor 8 and a logic IC 19 that stops driving of the motor 8 if the cap body 5 is open or the overcurrent is flowing through the motor 8.

The motor drive circuit 15 is equipped with an H bridge circuit etc. to constitute drive means so that the motor 8 may be driven in a normal direction or and an inverse direction.

The current detection circuit 16 is equipped with an amplification circuit etc. to constitute current detection means, thereby detecting a current flowing through the motor 8 and outputting a current value signal MC.

The control section 17 is equipped with a CPU, a memory, etc. to constitute control means and receives an OPEN/CLOSE signal D1 from the first cap switch 11a and an OPEN/CLOSE signal D2 from the second cap switch 11b, to decide whether the cap body 5 is normally closed in accordance with the OPEN/CLOSE signals D1 and D2.

In the present example, as shown in FIG. 3, the manipulation such that the cap body 5 is attached to the throwing opening 4 and turned to lock under its closed condition enables the third magnet 12c and the first magnet 12a to face the first cap switch 11a sequentially. Accordingly, the OPEN/CLOSE signal D1 output from the first cap switch 11a changes, for example, from the OFF state to the ON state, to the OFF state, and then to the ON state.

Since the second magnet 12b faces the second cap switch 11b, the OPEN/CLOSE signal D2 output from the second cap switch 11b changes, for example, from the OFF state to the ON state.

The control section 17 monitors the OPEN/CLOSE signals D1, D2 and, if receiving the OPEN/CLOSE signals D1, D2 each indicating that the cap body 5 is closed, the control section 17 decides, based on a pattern of the transition, whether an operation to close the cap body 5 is performed, and then, if deciding that no operation to close the cap body 5 is performed, the control section 17 avoids driving the motor 8.

Further, the OPEN/CLOSE signal D1 indicating that the cap body 5 is closed is continually received from the first cap switch 11a within a predetermined interruption period of time and the number of times of detection has reached a predetermined number of times of open/closes state decision and, simultaneously, the OPEN/CLOSE signal D2 indicating that the cap body 5 is closed is continually received from the second cap switch 11b within an interruption period of time and the number of times of detection has reached the number of times of open/closed state decision, the control section 17 decides that the cap body 5 is normally closed.

When having decided that the cap body 5 is closed, the control section 17 outputs normal revolution instruction signals FP1, FN1 to instruct normal revolution of the motor 8 and reverse revolution instruction signals RP2, RN2 to instruct reverse revolution of the motor 8 alternately for every predetermined period of time, to control the motor 8 so that it may repeat normal revolution and reverse revolution for every predetermined period of time.

On the other hand, if the OPEN/CLOSE signal indicating that the cap body 5 is closed is not received continually, it decides that the cap body 5 is open and stops outputting of the normal revolution instruction signals FP1, FN1 and the reverse revolution instruction signals RP2, RN2.

Further, the control section 17 receives the current value signal MC output from the current detection circuit 16, to decide whether an overcurrent is flowing through the motor 8.

In the present example, when having output the normal revolution instruction signals FP1, FN1 or the reverse revolution instruction signals RP2, RN2 to start driving of the motor 8, the control section 17 waits for a predetermined standby period of time and then monitors whether a current value is not smaller than a threshold value. It accumulates the current values after having detected a current that is not smaller than the threshold value and, if an accumulated average value is not smaller than the threshold value, it decides that an overcurrent is flowing.

If a period of the overcurrent detection time exceeds a predetermined period of the overcurrent detection set time, the control section 17 outputs the reverse revolution instruction signals RP2, RN2 if it has output the normal revolution instruction signals FP1, FN1 or outputs the normal revolution instruction signals FP1, FN1 if it has output the reverse revolution instruction signals RP2,RN2, to reverse the revolution direction of the motor 8.

Moreover, the control section 17 counts the number of times of detecting the overcurrent and, if the number of times of the reverse revolutions exceeds a predetermined number of times for error decisions, controls the motor 8 to stop driving it.

It is to be noted that the standby time is set in order to prevent the overcurrent from being detected as an inrush current because the inrush current occurs in excess of the threshold value that may be decided to be the overcurrent, immediately after the motor 8 starts revolving.

The overcurrent detection circuit 18 is equipped with a hardware timer circuit that utilizes a capacitor, a comparator, etc. and a latch circuit that holds an output of the hardware timer circuit, to constitute overcurrent detection means.

The overcurrent detection circuit 18 receives the current value signal MC output from the current detection circuit 16 and, if an overcurrent in excess of a predetermined value flows through the motor 8, it charges the capacitor constituting the hardware timer circuit.

If the overcurrent continues to flow through the motor 8, in the overcurrent detection circuit 18, an inter-terminal voltage of the capacitor reaches a reference voltage in a timer actuation time which is set by a time constant of the circuit, whereupon an output of, for example, the hardware timer circuit is turned ON, which in turn causes the latch circuit to operate so that an overcurrent detection signal OC may continue to be output.

In this case, if an overcurrent flows through the motor 8 but the control section 17 is normally operating, the motor 8 is controlled to revolve inversely when the period of overcurrent detection time exceeds the period of overcurrent detection set time, as described above. In the control to reverse revolution driving of the motor 8, the motor 8 is once stopped, the capacitor constituting the hardware timer circuit in the overcurrent detection circuit 18 is discharged.

In the overcurrent detection circuit 18, a period of timer actuation time when the inter-terminal voltage of the capacitor reaches the reference voltage is set longer than the period of overcurrent detection set time for driving the motor 8 inversely. Accordingly, even if an overcurrent flows through the motor 8, as far as the control section 17 is operating normally, the motor 8 is controlled so as to be driven inversely before the inter-terminal voltage of the capacitor reaches the reference voltage, thereby preventing the overcurrent detection circuit 18 from outputting the overcurrent detection signal OC.

On the other hand, if the control section 17 does not normally operate so that an overcurrent may continue to flow through the motor 8, the overcurrent detection signal OC is output after the timer actuation time elapses, as described above.

The logic IC 19 is equipped with a logical IC etc. to constitute logical operation means. The logic IC 19 receives the OPEN/CLOSE signal D1 output from the first cap switch 11a and the OPEN/CLOSE signal D2 output from the second cap switch 11b. It also receives the overcurrent detection signal OC output from the overcurrent detection circuit 18. Moreover, it further receives the normal revolution instruction signals FP1, FN1 and the reverse revolution instruction signals RP2, RN2 output from the control section 17.

The logic IC 19 is configured so that, when receiving the normal revolution instruction signal FP1 or the reverse revolution instruction signal RP2 from the control section 17, it can output the normal revolution drive signal P1 or a reverse revolution drive signal P2 in response to the OPEN/CLOSE signal D1 received from the first cap switch 11a and the overcurrent detection signal OC received from the overcurrent detection circuit 18.

Further, the logic IC 19 is also configured so that, when receiving the normal revolution instruction signal FN1 or the reverse revolution instruction signal RN2 from the control section 17, it can output a normal revolution drive signal N1 or a reverse revolution drive signal N2 in response to the OPEN/CLOSE signal D2 received from the second cap switch 11b and the overcurrent detection signal OC received from the overcurrent detection circuit 18.

That is, when the normal revolution instruction signals FP1, FN1 are output from the control section 17 to drive the motor 8 normally, the logic IC 19 outputs the normal revolution drive signal P1 if it receives the normal revolution instruction signal FP1 from the control section 17 and the OPEN/CLOSE signal D1 indicating that the cap body 5 is closed from the first cap switch 11a but does not receive the overcurrent detection signal OC from the overcurrent detection circuit 18.

Similarly, it outputs the normal revolution drive signal N1 if it receives the normal revolution instruction signal FN1 from the control section 17 and the OPEN/CLOSE signal D2 indicating that the cap body 5 is closed from the second cap switch 11b but does not receive the overcurrent detection signal OC from the overcurrent detection circuit 18.

On the other hand, if receiving the OPEN/CLOSE signal D1 indicating that the cap body 5 is open from the first cap switch 11a or the overcurrent detection signal OC from the overcurrent detection circuit 18, it does not output the normal revolution drive signal P1 even if receiving the normal revolution instruction signal FP1.

Further, if receiving the OPEN/CLOSE signal D2 indicating that the cap body 5 is open from the second cap switch 11b or the overcurrent detection signal OC from the overcurrent detection circuit 18, it does not output the normal revolution drive signal N1 even if receiving the normal revolution instruction signal FN1.

When receiving the normal revolution drive signals P1, N1, the motor drive circuit 15 drives the motor 8 in normal direction. Then, in a condition where the cap body 5 is open or the overcurrent flows through the motor 8, none of the normal revolution drive signals P1, N1 is output from the logic IC 19 and the motor 8 is not driven even if receiving the normal revolution instruction signal FP1 or FN1 owing to malfunctioning of the control section 17 etc.

Further, since the normal revolution drive signal P1 is output in response to the OPEN/CLOSE signal D1 received from the first cap switch 11a and the normal revolution drive signal N1 is output in response to the OPEN/CLOSE signal D2 received from the second cap switch 11b, even if any one of the first cap switch 11a and the second cap switch 11b detects that the cap body 5 is closed, the logic IC 19 outputs only either one of the normal revolution drive signal P1 and the normal revolution drive signal N1 and thus, the motor 8 is not driven.

If the reverse revolution instruction signal RP2 or RN2 is output from the control section 17 in order to drive the motor 8 inversely, the logic IC 19 outputs the reverse revolution drive signal P2 if it receives the reverse revolution instruction signal RP2 from the control section 17 and the OPEN/CLOSE signal D1 indicating that the cap body 5 is closed from the first cap switch 11a but does not receive the overcurrent detection signal OC from the overcurrent detection circuit 18.

Similarly, it outputs the reverse revolution drive signal N2 if it receives the reverse revolution instruction signal RN2 from the control section 17 and the OPEN/CLOSE signal D2 indicating that the cap body 5 is closed from the second cap switch 11b but does not receive the overcurrent detection signal OC from the overcurrent detection circuit 18.

On the other hand, if receiving the OPEN/CLOSE signal D1 indicating that the cap body 5 is open from the first cap switch 11a or the overcurrent detection signal OC from the overcurrent detection circuit 18, it does not output the reverse revolution drive signal P2 even if receiving the reverse revolution instruction signal RP2.

Further, if receiving the OPEN/CLOSE signal D2 indicating that the cap body 5 is open from the second cap switch 11b or the overcurrent detection signal OC from the overcurrent detection circuit 18, it does not output the reverse revolution drive signal N2 even if receiving the reverse revolution instruction signal RN2.

When receiving the reverse revolution drive signals P2, N2, the motor drive circuit 15 drives the motor 8 inversely. Then, in a condition where the cap body 5 is open or the overcurrent flows through the motor 8, none of the reverse revolution drive signals P2 and N2 is output from the logic IC 19 and thus, the motor 8 is not driven even if receiving the reverse revolution instruction signal RP2 or RN2 owing to malfunctioning of the control section 17 etc.

Further, since the reverse revolution drive signal P2 is output in response to the OPEN/CLOSE signal D1 received from the first cap switch 11a and the reverse revolution drive signal N2 is output in response to the OPEN/CLOSE signal D2 received from the second cap switch 11b, even if it is detected that any one of the first cap switch 11a and the second cap switch 11b detects that the cap body 5 is closed, the logic IC 19 outputs only either one of the reverse revolution drive signal P2 and the reverse revolution drive signal N2 and thus, the motor 8 is not driven.

<Example of Configuration of Crushing Unit in Garbage Disposal>

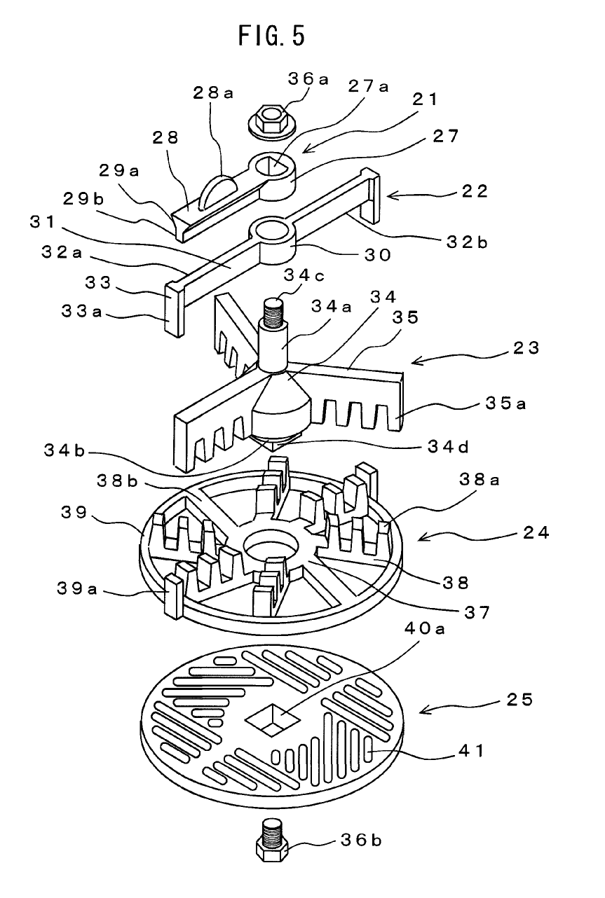

FIGS. 4 and 5 show the crushing unit 6 constituting the garbage disposal 1 of the present embodiment: FIG. 4 is a front cross-sectional view of the crushing unit 6; and FIG. 5 is a perspective view of an exploded important portion of the crushing unit 6.

The crushing unit 6 has a single unit constitution such that a first crushing rotary blade 21, a second crushing fixed blade 22, a third crushing rotary blade 23, a fourth crushing fixed blade 24, and a fifth crushing rotary blade 25 shown in FIG. 5 are contained in a housing 26 as shown in FIG. 4.

The housing 26, which has a cylinder shape, is inserted into the hopper 3 shown in FIG. 2 through the throwing opening 4 and fixed therein in a predetermined orientation. The crushing unit 6 fixed in the hopper 3 constitutes a crushing chamber with the housing 26 held on an inner circumferential surface of the hopper 3.

The housing 26 has a flange section 26a formed at a lower end of the inner circumferential surface thereof. As shown in FIG. 4, the crushing blades are contained in the housing 26, with the fourth crushing fixed blade 24 held on the flange section 26a.

From an upper end down to a lower end of the inner circumferential surface of the housing 26, two vertical grooves 26b are formed with angular spacing of 180 degrees held between them. As described later, the second crushing fixed blade 22 and the fourth crushing fixed blade 24 have such a shape as to be engaged with the vertical grooves 26b, which is held so that they cannot revolve against the housing 26.

Moreover, the housing 26 is equipped with a handle 26c, by which the crushing unit 6 can be attached to and detached from the hopper 3 in a condition where the handle 26c is gripped.

As shown in FIG. 5, the first crushing rotary blade 21 is equipped with one stirring arm 28 that horizontally extends from a side of a roller bearing section 27 in such a configuration that squeeze-in faces 29a are formed in both of front and rear surfaces of the stirring arm 28 in the rotation direction.

Each of the squeeze-in faces 29a is an inclined plane that is inclined in a direction in which the upper end thereof protrudes with respect to the lower end thereof on each side of the stirring arm 28. Forming the squeeze-in faces 29a in both sides of the stirring arm 28 enables the first crushing rotary blade 21 to be apply any downward pressing force on the garbage which comes in contact with the squeeze-in faces 29a in revolution operation in both of the directions. Accordingly, the first crushing rotary blade 21 takes in the garbage and squeezes it into the lower-stage crushing blades by revolving operation thereof.

Further, the first crushing rotary blade 21 has edges 29b formed at the lower ends of the squeeze-in faces 29a, which cooperates with the second crushing fixed blade 22 to function as a crushing blade that coarsely crushes the garbage.

Moreover, the first crushing rotary blade 21 has a handle 28a formed on an upper surface of the stirring arm 28. The first crushing rotary blade 21 has such a configuration as to revolve in a condition where it is integrated with each of the crushing rotary blades, so that by forming the handle 28a on the top-stage first crushing rotary blade 21, the crushing rotary blades can revolve without coming in contact with the crushing blade directly.

That is, in the case of adjusting an orientation of each of the crushing rotary blades in order to be coupled with the drive shaft 7a when the crushing unit 6 shown in FIG. 4 is fixed on the hopper 3 as shown in FIG. 2, by operating the handle 28a, the orientation of the crushing rotary blade can be adjusted without coming in contact with the crushing blade directly.

The first crushing rotary blade 21 has a shaft attaching hole 27a formed through the roller bearing section 27. The shaft attaching hole 27a has a roughly D-shaped cross section, so that a later-described shaft section of the third crushing rotary blade 23 can be fit into it in a condition where it cannot revolve.

The second crushing fixed blade 22 is equipped with two arms 31 which horizontally extend from a hub 30 with angular spacing of 180 degrees held between them. The arms 31, each of which has a plane shape, each have edges 32a and 32b formed at upper and lower ends of its two sides and cooperate with the above-described first crushing rotary blade 21 and the third crushing rotary blade 23 to function as a crushing blade.

Each of the arms 31 has a tab 33 formed at the tip thereof. The tabs 33 are respectively fitted into the vertical grooves 26b in the housing 26 shown in FIG. 4, to restrain the second crushing fixed blade 22 from revolving. Further, each of the tabs 33 has a leg section 33a formed on it so that a gap having a predetermined height may be given between the second crushing fixed blade 22 and the fourth crushing fixed blade 24. Moreover, an inner diameter of the hub 30 is set larger than a diameter of a later-described shaft section of the third crushing rotary blade 23 so that it may not interfere with the shaft section of the third crushing rotary blade 23.

The third crushing rotary blade 23 is equipped with three arms 35 which radially extend from the hub 34 with angular spacing of 120 degrees held between them. Each of the arms 35 has a comb-teeth section 35a with a predetermined inter-tooth pitch formed on their bottom.

The hub 34 of the third crushing rotary blade 23 is equipped with a first shaft section 34a on its upper side and a second shaft section 34b on its lower side as shown in FIG. 4. The first shaft section 34a is fitted into the hub 30 of the second crushing fixed blade 22 in a rotatable manner. The first shaft section 34a has a roughly D-shaped cross section at an upper end thereof so that it may be fitted into the shaft attaching hole 27a of the first crushing rotary blade 21 in such a manner that it cannot revolve. Moreover, at the tip of the first shaft section 34a, a screw section 34c is formed to which a nut 36a is screwed.

To the second shaft section 34b, the fourth crushing fixed blade 24 is fitted in a rotatable manner. The second shaft section 34b has a square shank section 34d formed at the lower end thereof, which is fitted into the fifth crushing rotary blade 25. Moreover, in a bottom surface of the square shank section 34d, a screw hole 34e is formed into which a screw 36b is screwed as shown in FIG. 4.

The fourth crushing fixed blade 24 has such a shape that a ring 39 may enclose equally spaced eight arms 38 which radially extend from a hub 37 in a direction of a tangential line. On an outer circumference of the ring 39, tabs 39a are formed so as to radially protrude with angular spacing of 180 degrees held between them. The tabs 39a are fitted into the vertical grooves 26b in the housing 26 shown in FIG. 4, to restrain the fourth crushing fixed blade 24 from revolving.

Further, each of the tabs 39a has a predetermined height, so that by placing the leg section 33a of the second crushing fixed blade 22 on an upper surface of the tab 39a, a gap having a predetermined height to let in the third crushing rotary blade 23 is given between the second crushing fixed blade 22 and the fourth crushing fixed blade 24. Moreover, an inner diameter of the hub 37 is set larger than a diameter of the second shaft section 34b of the third crushing rotary blade 23 so that it may not interfere with the second shaft section 34b.

Each of the six arms 38 out of the eight arms 38 of the fourth crushing fixed blade 24 has a comb-teeth section 38a formed on their upper surface. The comb-teeth section 38a of the fourth crushing fixed blade 24 has a pitch in which it may mesh with the comb-teeth section 35a of the third crushing rotary blade 23, so that when the third crushing rotary blade 23 and the fourth crushing fixed blade 24 are put one on another as shown in FIG. 4, both of the comb-teeth sections 35a and 38a come to mesh with each other with a slight gap held between them.

In this constitution, the comb-teeth section 38a of the fourth crushing fixed blade 24 cooperates with the comb-teeth section 35a of the third crushing rotary blade 23, to crush the garbage sent over from the upper-stage crushing blades.

As described above, since the third crushing rotary blade 23 has the three arms 35 and the fourth crushing fixed blade 24 has the eight arms 38, spacing between the arms 38 is smaller than that between the arms 35.

Therefore, if all of the eight arms 38 is equipped with the comb-teeth section 38a, the comb-teeth section 38a of the fourth crushing fixed blade 24 always exists between the arms 35 of the third crushing rotary blade 23, so that if block-shaped garbage having a certain size is thrown in, such a phenomenon breaks out that the garbage cannot be inserted between the arms 35 of the third crushing rotary blade 23 and cannot be crushed easily.

To solve this problem, if, for example, each of the two arms 38b of the eight arms 38 of the fourth crushing fixed blade 24 is not equipped with the comb-teeth section 38a, a wide space may be given circumferentially when these arms 38b not provided with the comb-teeth section 38a of the fourth crushing fixed blade 24 are positioned between the arms 35 of the third crushing rotary blade 23 during revolution of the third crushing rotary blade 23.

With this, even if garbage having a certain size is thrown in, the garbage can be inserted between the arms 35 of the third crushing rotary blade 23 and be crushed by the comb-teeth section 35a and the comb-teeth section 38a of the other arms 38 of the fourth crushing fixed blade 24 that cooperate due to revolution of the third crushing rotary blade 23.

It is to be noted that if more arms 38b of the fourth crushing fixed blade 24 are not equipped with the comb-teeth section 38a, a crushing ability is deteriorated, so that in the case of providing, for example, the eight arms 38, preferably about two of the arms 38b are not equipped with the comb-teeth section 38a.

Further, radially extending the arms 38 in a direction of a tangential line of the hub 37 enables to circumferentially shift a point where the fourth crushing fixed blade 24 and the third crushing rotary blade 23 are engaged when the blade 23 revolves, thereby controlling a peak of crushing load and making the load flattened.

The fifth crushing rotary blade 25 has a disk shape and has a lot of slits 41 arrayed everywhere except a hub 40 shown in FIG. 4. It is to be noted that in the fifth crushing rotary blade 25 of the present example, a plurality of slit groups are formed, in each of which the adjacent slits 41 are arranged roughly in parallel.

The fifth crushing rotary blade 25 has a planar upper surface and revolves with it being in contact with bottom surfaces of the arms 38 of the fourth crushing fixed blade 24. Further, the slits 41 go through the fifth crushing rotary blade 25, to have a sharp edge formed at an opening in its upper surface.

Garbage that is crushed between the comb-teeth section 35a of the third crushing rotary blade 23 and the comb-teeth section 38a of the fourth crushing fixed blade 24 and dropped on the upper surface of the fifth crushing rotary blade 25 is caught in the slits 41 and pressed into them owing to revolution of the fifth crushing rotary blade 25 so that it may be crushed by the edges of the slits 41. Then, the finely crushed garbage goes through the slits 41, is dropped downward, passes through the bottom plate 10 of the hopper 3 shown in FIG. 2, and discharged to outside through the drain connection opening 9.

At a midsection of the slit 41, a step section is formed as shown in FIG. 4 to expand an opening in the bottom surface more than an opening in the upper surface so that garbage pressed into each of the slits 41 may easily drop.

The hub 40 of the fifth crushing rotary blade 25 has, a square hole 40a, into which the square shank section 34d of the third crushing rotary blade 23 is fitted, formed at its upper surface. Further, in a bottom surface of the hub 40, a square hole 40b is formed, into which the drive shaft 7a shown in FIG. 1 is fitted. Moreover, between the square holes 40a and 40b, a through hole 40c through which the screw 36b passes is formed.

The following will describe a condition where the crushing blades are assembled with reference to FIGS. 4 and 5. The hub 37 of the fourth crushing fixed blade 24 is revolvably fitted to the second shaft section 34b of the third crushing rotary blade 23 and the square shank section 34d of the second shaft section 34b is fitted into the square hole 40a in the fifth crushing rotary blade 25.

Then, the screw 36b is screwed into the screw hole 34e in the square shank section 34d from a side of the square hole 40b in the fifth crushing rotary blade 25, to integrate the third crushing rotary blade 23 and the fifth crushing rotary blade 25.

Further, the hub 30 of the second crushing fixed blade 22 is revolvably fitted into the first shaft section 34a of the third crushing rotary blade 23 and the first shaft section 34a is fitted into the shaft attaching hole 27a in the first crushing rotary blade 21 in such a manner that it cannot revolve.

Then, the nut 36a is screwed to the screw section 34c of the first shaft section 34a to integrate the first crushing rotary blade 21 and the third crushing rotary blade 23, so that the first crushing rotary blade 21, the third crushing rotary blade 23, and the fifth crushing rotary blade 25 are integrated with the second crushing fixed blade 22 and the fourth crushing fixed blade 24 being sandwiched therebetween.

It is to be noted that the crushing blades integrated as described above are attached to the housing 26 by fitting the tabs 33 of the second crushing fixed blade 22 and the tabs 39a of the fourth crushing fixed blade 24 into the vertical grooves 26b of the housing 26 so that the second crushing fixed blade 22 and the fourth crushing fixed blade 24 may be held to the housing 26 in such a manner that it cannot revolve.

Then, a holding attachment 26d is fitted into the vertical groove 26b and fixed with a screw etc., not shown, to thereby hold the crushing blades with the holding attachment 26d and the flange section 26a in such a manner that they cannot move vertically. Accordingly, the first crushing rotary blade 21, the third crushing rotary blade 23, and the fifth crushing rotary blade 25 can revolve with respect to the housing 26.

As shown in FIG. 4, the first crushing rotary blade 21, the second crushing fixed blade 22, the third crushing rotary blade 23, the fourth crushing fixed blade 24, and the fifth crushing rotary blade 25 are sized so that they may be put on one another with little gap vertically, to prevent crushed garbage from being inserted into the vertical gap between the crushing blades and being left in the crushing unit 4.

<Example of Control of operations for Closing Cap Body>

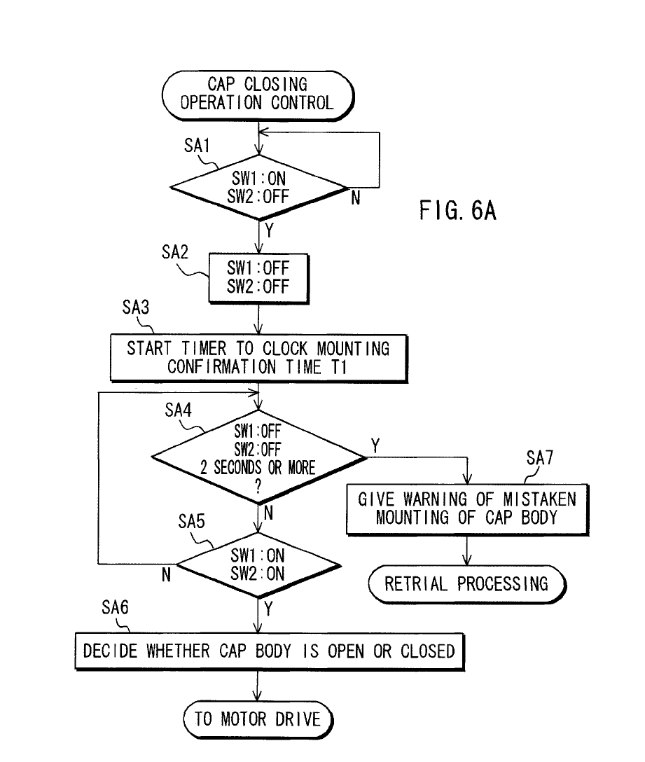

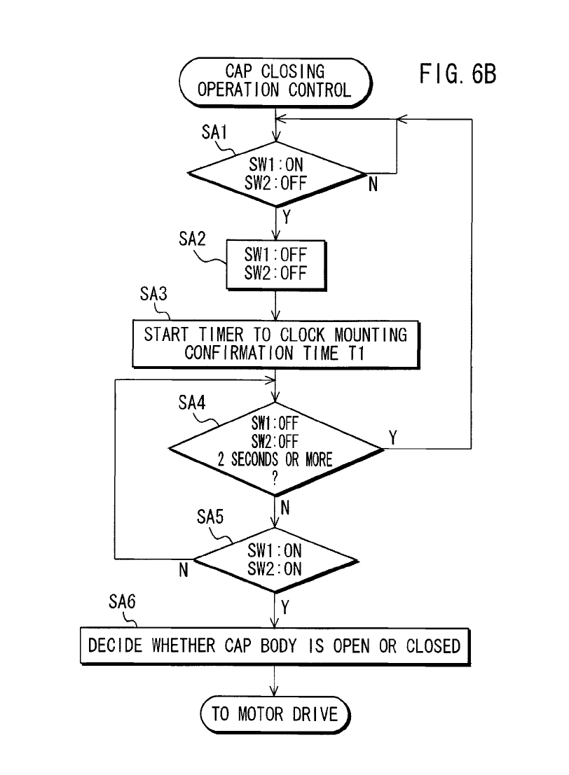

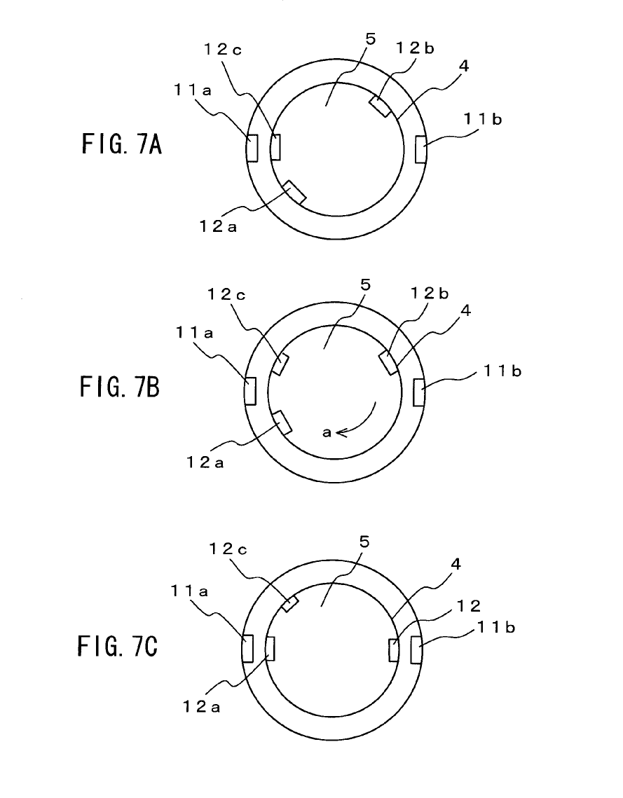

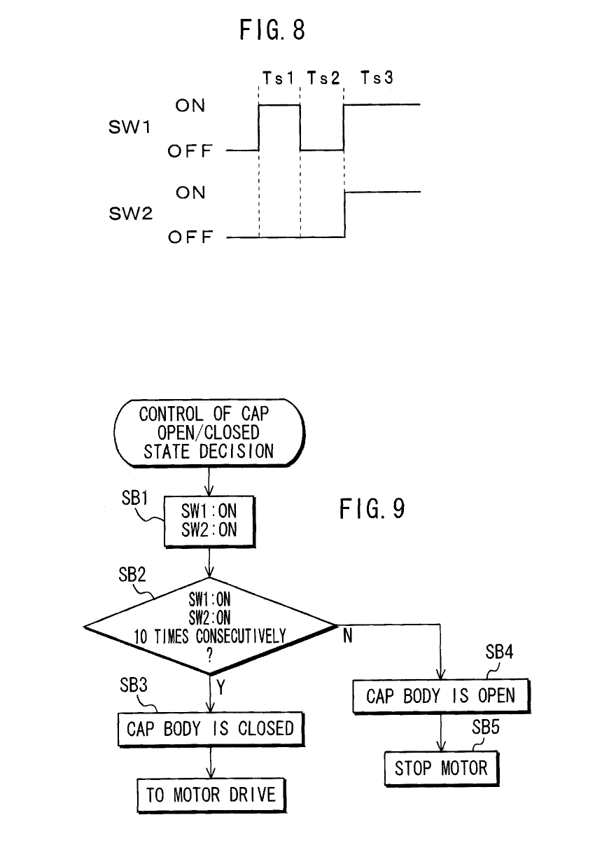

FIGS. 6A and 6B are flowcharts each for showing an example of processing when the cap body 5 is closed, FIGS. 7A through 7C are explanatory illustrations each for showing operations for closing the cap body 5, and FIG. 8 is a timing chart for showing output patterns of the first cap switch 11a and the second cap switch 11b when the cap body 5 is closed; first, control of operations when the cap body 5 is closed will be described, with reference to the flowchart of FIG. 6A. It is to be noted that in the figures, the first cap switch 11a is shown as SW1 and the second cap switch 11b as SW2.

Step SA1: The cap body 5 is fitted into the throwing opening 4 in a predetermined orientation. By fitting the cap body 5 into the throwing opening 4 in the predetermined orientation as shown in FIG. 7A, the third magnet 12c of the cap body 5 faces the first cap switch 11a of the throwing opening 4. At this stage, no magnet faces the second cap switch 11b.

Accordingly, as shown in FIG. 8, the OPEN/CLOSE signal D1 output from the first cap switch 11a (SW1) is turned ON and the OPEN/CLOSE signal D2 output from the second cap switch 11b (SW2) is turned OFF at Ts1.

Step SA2: The cap body 5 is turned in a direction to be locked under its closed condition. By turning the cap body 5 in the direction to be locked of an arrow “a” shown in FIG. 7B under its closed condition, the third magnet 12c gets out of a position that faces the first cap switch 11a. At this stage, no magnet faces the second cap switch 11b.

Accordingly, as shown in FIG. 8, the OPEN/CLOSE signal D1 output from the first cap switch 11a is turned OFF and the OPEN/CLOSE signal D2 output from the second cap switch 11b is turned OFF at Ts2.

Step SA3: The control section 17 described in FIG. 1 monitors the outputs of the first cap switch 11a and the second cap switch 11b and, if the OPEN/CLOSE signal D1 output from the first cap switch 11a turns from the ON state to the OFF state, it starts a timer to clock a mounting confirmation time T1. In the present example, the mounting confirmation time T1 is set to, for example, two seconds.

Step SA4: The control section 17 decides whether a period of mounting confirmation time T1 has elapsed since the OPEN/CLOSE signal D1 output from the first cap switch 11a changed from the ON state to the OFF state.

Step SA5: If having decided that the period of mounting confirmation time T1 has not yet elapsed, the control section 17 monitors the outputs of the first cap switch 11a and the second cap switch 11b to decide whether the OPEN/CLOSE signal D1 output from the first cap switch 11a and the OPEN/CLOSE signal D2 output from the second cap switch 11b are both turned ON.

Step SA6: If having decided that the OPEN/CLOSE signal D1 output from the first cap switch 11a and the OPEN/CLOSE signal D2 output from the second cap switch 11b are both turned ON, the control section 17 decides that the cap body 5 has been closed normally.

When the cap body 5 is turned to the position where it is locked under its closed condition, as shown in FIG. 7C, the first magnet 12a faces the first cap switch 11a and the second magnet 12b faces the second cap switch 11b. Accordingly, as shown in FIG. 8, the OPEN/CLOSE signal D1 output from the first cap switch 11a is turned ON and the OPEN/CLOSE signal D2 output from the second cap switch 11b is turned ON at Ts3.

If, as shown in FIG. 8, after the OPEN/CLOSE signal D1 output from the first cap switch 11a is changed from the ON state to the OFF state, the OPEN/CLOSE signal D1 and the OPEN/CLOSE signal D2 output from the second cap switch 11b are turned ON at the same timing, the control section 17 decides that the cap body 5 has been closed normally, to decide whether the cap body 5 is open or closed as described later and, if having decided that the cap body 5 is closed, it drives the motor 8.

In the present example, if the OPEN/CLOSE signal D1 and the OPEN/CLOSE signal D2 are not turned ON at the same timing after the OPEN/CLOSE signal D1 is changed from the ON state to the OFF state, the control section 17 does not decide that the cap body 5 is closed.

In such a manner, even if, by inserting the human arm wearing a magnetic bracelet or the like into the throwing opening 4 during washing or the like of the crushing blades, the first cap switch 11a and the second cap switch 11b detect magnetism of the magnetic bracelet to thereby change the OPEN/CLOSE signals D1 and D2 at the same timing, the control section 17 does not decide that the cap body 5 is closed so that the motor 8 can not be driven. Thus, the motor 8 is prevented from being driven mistakenly, to improve its safety.

Step SA7: If having decided at step SA4 that the period of mounting confirmation time T1 has elapsed, the control section 17 sounds a buzzer 20 to give a warning.

In the present example, if the OPEN/CLOSE signal D1 output from the first cap switch 11a is changed from the ON state to the OFF state, it is decided that the operation for closing the cap body 5 starts. If both of the OPEN/CLOSE signal D1 output from the first cap switch 11a and the OPEN/CLOSE signal D2 output from the second cap switch 11b are not turned ON even after the period of mounting confirmation time T1 has elapsed, it decides that the cap body 5 is mounted mistakenly because, for example, turning operations to be locked under its closed condition are not performed normally although the cap body 5 is fitted into the throwing opening 4 and then, the buzzer 20 sounds. This enables a user to be warned in that the cap body 5 is not normally closed.

It is to be noted that in a case where the cap body 5 is deviated from the throwing opening 4, none of the first cap switch 11a and the second cap switch 11b detects magnetism, so that the OPEN/CLOSE signals D1 and D2 are both in the OFF state. In a case where the OPEN/CLOSE signal D1 does not change from the ON state to the OFF state and the OPEN/CLOSE signals D1 and D2 are both in the OFF state, it decides that the cap body 5 is open and then, the buzzer 20 does not sound. In such a manner, no warning is given if the cap body 5 is open usually, to make it possible to distinguish between a case where the cap body 5 is open usually and a case where it is mounted mistakenly and warn the user of mistaken mounting of the cap body 5.

Further, after a warning is given in a case where the cap body 5 is mounted mistakenly, retrial processing can be performed to detach the cap body 5 once and mount it again, thereby preventing a mistake in detection and improving safety.

In the present example, although the buzzer 20 has sounded to give a warning to the user at the above-described step SA7, it is possible to use display means such as a light emitting diode (LED) in place of the buzzer 20, to give a lit warning as far as a warning signal can be output at step SA7 which can operate warning means equipped to the garbage disposal 1.

Further, as shown in the flowchart of FIG. 6B, if it is decided that the period of mounting confirmation time T1 has elapsed at step SA4, in place of step SA7 shown in the flowchart of FIG. 6A, the control may be returned to the step immediately preceding the step SA1.

In this case also, it is necessary to detach the cap body 5 once and mount it again along a normal procedure, to enable to prevent a mistake in detection and to improve safety.

<Example of Software Processing to Decide Whether Cap Body is Open or Closed>

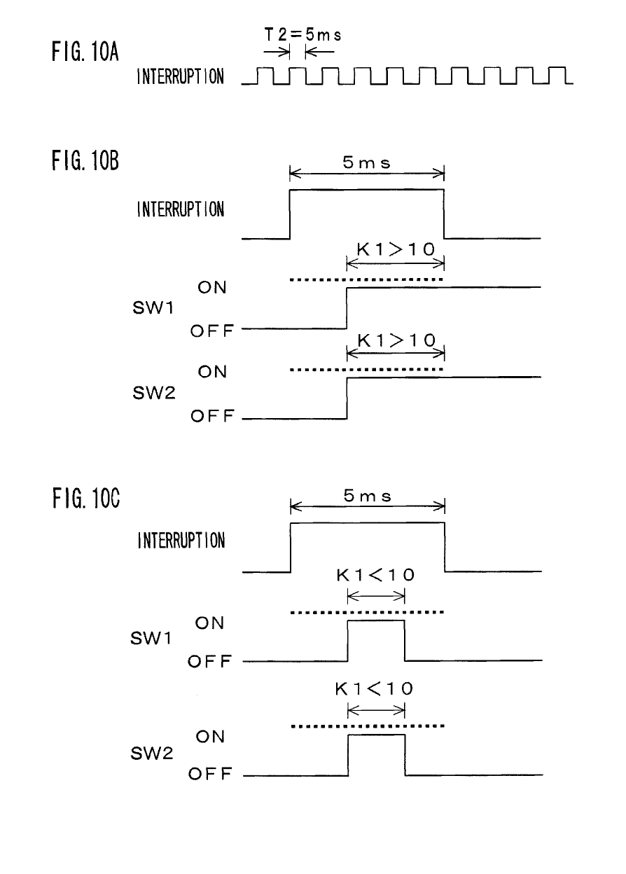

FIG. 9 is a flowchart for showing an example of processing to decide whether the cap body 5 is open or closed, FIGS. 10A through 10C are timing charts for showing output patterns of the first cap switch 11a and the second cap switch 11b caused by opening and closing of the cap body 5 and their interruption timings, which is followed by description of control to be conducted when it is decided whether the cap body 5 is open or closed.

Step SB1: If the cap body 5 is locked to the throwing opening 4 under its closed condition in the operation to close the cap body 5, as described at step SA6 of FIGS. 6A and 6B, the OPEN/CLOSE signal D1 output from the first cap body 11a and the OPEN/CLOSE signal D2 output from the second cap body 11b are both turned ON.

Step SB2: The control section 17 monitors the outputs of the first cap switch 11a and the second cap switch 11b for every predetermined period of interruption time T2. If the outputs of the first cap switch 11a and the second cap switch 11b are both turned ON arid the OPEN/CLOSE signals D1 and D2 that indicate that the cap body 5 is closed are input, it consecutively detects the ON states of the OPEN/CLOSE signal D1 and that of the OPEN/CLOSE signal D2 within the period of interruption time T2 and decides whether the number of times of turning-ON has reached a predetermined number of times of OPEN/CLOSE-state decision K1. In the present example, the interruption time T2 is set to 5 ms and the number of times of OPEN/CLOSE-state decision K1 is set to 10.

Step SB3: If having consecutively detected the ON states of the OPEN/CLOSE signal D1 and that of the OPEN/CLOSE signal D2 within the period of interruption time T2 (=5 ms) and having decided that the number of times of turning-ON has reached the number of times of OPEN/CLOSE-state decision K1 (=10), the control section 17 decides that the cap body 5 is closed normally. Then, it conducts control of driving of the motor 8, which will be described later.

Step SB4: If either one of the OPEN/CLOSE signals D1 and D2 is turned OFF before the number of times of turning-ON of the OPEN/CLOSE signals D1 and D2 reaches the number of times of OPEN/CLOSE-state decision K1, the control section 17 decides that the cap body 5 is open.

Step SB5: If having decided that the cap body 5 is open, the control section 17 controls the motor 8 to stop and holds the motor 8 in its stopped condition.

FIG. 10A shows an interruption timing at which reading of outputs of the first cap switch 11a and the second cap switch 11b happens. In the present example, the control section 17 reads outputs of the first cap switch 11a and the second cap switch 11b for every period of interruption time of 5 ms.

FIG. 10B shows state in which the cap body 5 is closed normally. When the cap body 5 is closed normally, the OPEN/CLOSE signal D1 output from the first cap switch 11a and the OPEN/CLOSE signal D2 output from the second cap switch 11b are turned ON consecutively.

Accordingly, if the cap body 5 is closed normally, the control section 17 consecutively detects the ON states of the OPEN/CLOSE signals D1 and D2 at least ten times for every period of interruption time of 5 ms and can decide that the cap body 5 is closed normally.

FIG. 10C shows a state of an abnormality such as a case where the cap body 5 is opened halfway. If the cap body 5 is opened, the OPEN/CLOSE signal D1 output from the first cap switch 11a and the OPEN/CLOSE signal D2 output from the second cap switch 11b change from the ON state thereof to the OFF state thereof.

Accordingly, at the time of an abnormality such as a case where the cap body 5 is opened halfway, frequencies when the control section 17 detects the ON states of the OPEN/CLOSE signals D1 and D2 within the period of interruption time is ten times or less so that it can decide that the cap body 5 is opened.

It is thus possible to certainly and immediately detect, for example, that the cap body 5 is opened by the user's OPEN/CLOSE operation by deciding whether the cap body 5 is open or closed based on the OPEN/CLOSE signal D1 output from the first cap switch 11a and the OPEN/CLOSE signal D2 output from the second cap switch 11b for every period of interruption time of 5 ms.

Therefore, in a case, for example, the cap body 5 is once closed and then opened, it is possible to hold the motor 8 at rest without starting driving it. Further, if the cap body 5 is opened even after the motor 8 starts in its driving, the driving of the motor 8 can stop immediately.

<Overall Flow of Motor Driving Control>

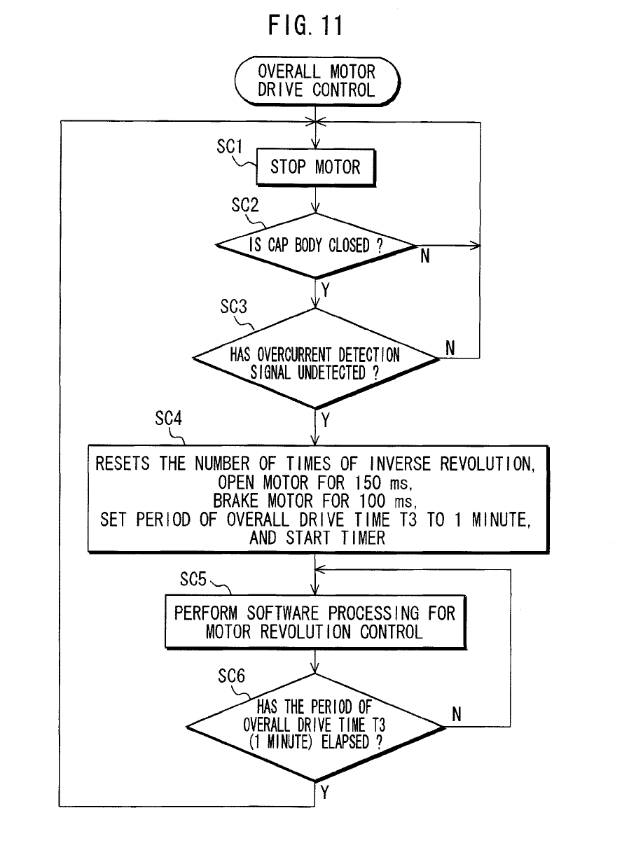

FIG. 11 is a flowchart for showing an example of overall processing of drive control on the motor 8, to describe first an overall flow of drive control on the motor 8.

Step SC1: The control section 17 stops driving the motor 8 until it decides that the cap body 5 is closed normally.

Step SC2: As described at the step SB2 of FIG. 9, the control section 17 decides that the cap body 5 is closed normally if it consecutively detects the ON state of the OPEN/CLOSE signal D1 output from the first cap switch 11a and the ON state of the OPEN/CLOSE signal D2 output from the second cap switch 11b within the period of interruption time T2 (=5 ms) and decides that the number of times of turning-ON has reached the predetermined number of times of OPEN/CLOSE-state decision K1 (=10).

Step SC3: If having decided that the cap body 5 is closed normally, the control section 17 decides whether the overcurrent detection signal OC output from the overcurrent detection circuit 18 has not yet detected.

Step SC4: If having decided that the overcurrent detection signal OC has not output from the overcurrent detection circuit 18 and has not yet detected, the control section 17 resets the number of times of inverse revolution to “0”. Further, it controls the motor drive circuit 15 to perform any stopping controls. Moreover, it starts the timer to start clocking of a period of overall drive time T3.

In the present example, as the stopping control, terminals of the motor 8 are opened to provide the open state. The period of time for the open state is, for example, 150 ms. Next, the terminals of the motor 8 are short circuited to set brake state. The period of time for the brake state is, for example, 100 ms. Then, after a period of time Tms (=250 ms) by means of stopping control elapses, it starts clocking the period of overall drive time T3. In the present example, the period of overall drive time is set to, for example, one minute.

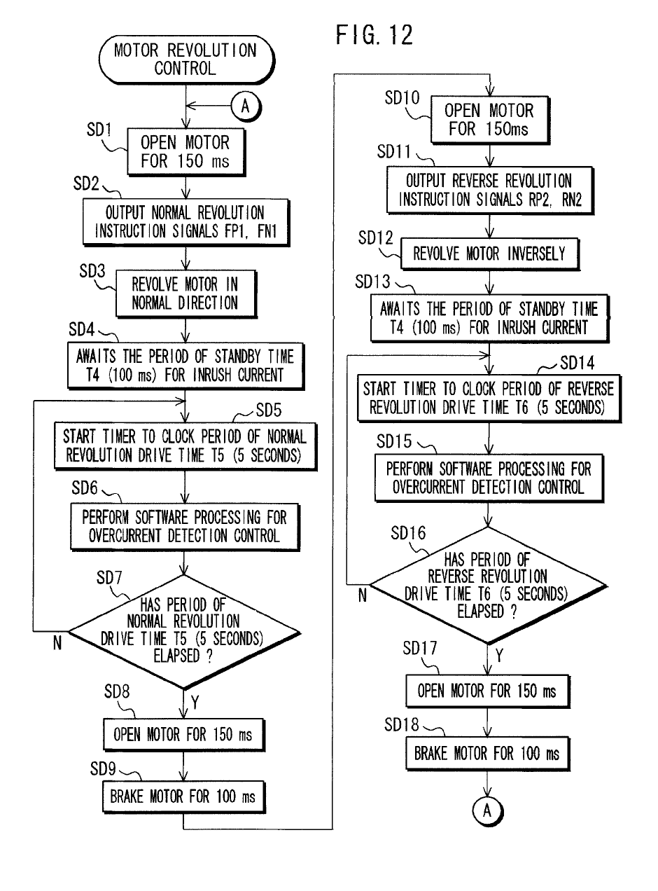

Step SC5: When clocking the period of overall drive time T3 starts after stopping control, the control section 17 controls revolution of the motor 8 as shown in FIG. 12, to be described later, in accordance with a predetermined program.

Step SC6: The control section 17 decides whether a period of the overall drive time T3 (=1 minute) has elapsed and, if it has elapsed, stops driving the motor 8.

<Software Processing of Motor Revolution Control>

FIG. 12 is a flowchart for showing an example of software processing of revolution control on the motor 8, which is followed by description of details of the revolution control on the motor 8.

Step SD1: The control section 17 opens the terminals of the motor 8 to provide its open state. The period of time Tmo for the open state is 150 ms, for example.

Step SD2: To drive the motor 8 in normal direction, the control section 17 first outputs the normal revolution instruction signals FP1, FN1. When the normal revolution instruction signals FP1, FN1 are output from the control section 17, if the cap body 5 is closed normally and no overcurrent is detected, the logic IC 19 outputs the normal revolution drive signals P1, N1. It is to be noted that fail safe functions by means of the logic IC 19 will be described later.

Step SD3: When receiving the normal revolution drive signals P1, N1, the motor drive circuit 15 drives the motor 8 in the normal direction. With this, the motor 8 starts revolving in the normal direction.

Step SD4: the control section 17 outputs the normal revolution instruction signals FP1, FN1 to start driving the motor 8 in the normal direction, and, it reads the current value signal MC output from the current detection circuit 16 after the period of standby time T4 has elapsed. In the present example, the period of standby time T4 is set to 100 ms.

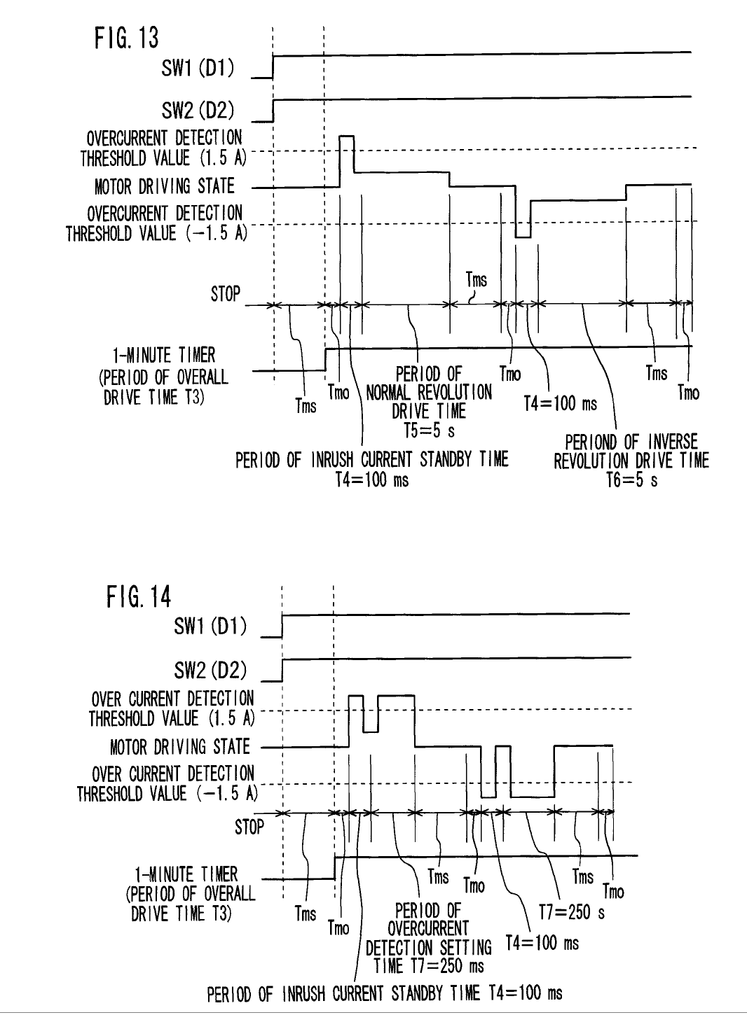

FIG. 13 is a timing chart for the motor drive control at the time of normal operations and FIG. 14 is a timing chart for the motor drive control at the time of an overcurrent. The timing charts of FIGS. 13 and 14 show waveforms of the OPEN/CLOSE signals D1 and D2 output from the first cap switch 11a and the second cap switch 11b, a waveform of a current flowing through the motor 8, a threshold value for detecting an overcurrent flowing through the motor 8, and an operating waveform of the timer which clocks the period of overall drive time T3.

When the motor 8 starts in its driving, an inrush current flows. As described later, the control section 17 reads the current value signal MC out of the current detection circuit 16 and decides whether an overcurrent is flowing.

The control section 17 sets a threshold value to decide an overcurrent to, for example, 1.5 A and decides a current, if equal to or larger than the overcurrent detection threshold value, as the overcurrent. However, the inrush current measures at least 1.5 A and so may be decided as an overcurrent mistakenly.

To solve this problem, during the period of standby time T4 (=100 ms) after starting of driving of the motor 8, the control section 17 does not read the current value signal MC out of the current detection circuit 16 so that overcurrent decision may not be performed. It is thus possible to prevent an inrush current from being decided as an overcurrent mistakenly.

Step SD5: When the control section 17 outputs the normal revolution instruction signals FP1, FN1 to start driving the motor 8 in the normal direction and then, the period of standby time T4 elapses, it starts the timer to start clocking a period of normal revolution drive time T5. In the present example, the period of normal revolution drive time T5 is set to five seconds.

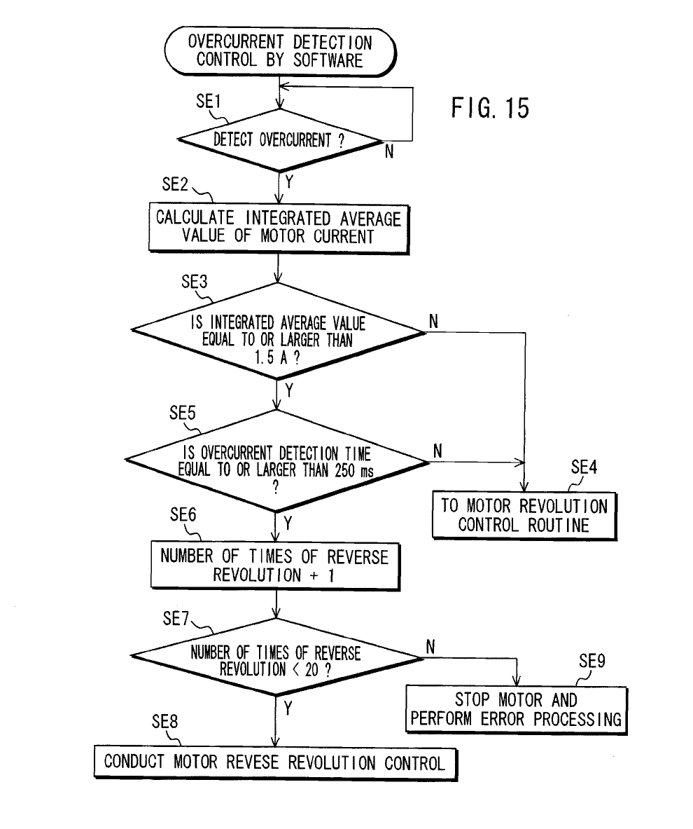

Step SD6: During driving the motor in revolution, the control section 17 conducts overcurrent detection control shown in FIG. 15, which will be described later, in accordance with a predetermine program.

Step SD7: The control section 17 decides whether a period of the normal revolution drive time T5 (=5 seconds) has elapsed.

Step SD8: When having decided that the period of normal revolution drive time T5 has elapsed, the control section 17 first opens the terminals of the motor 8 to provide the open state therebetween in order to stop normal revolution of the motor 8. A period of time for the open state is, for example, 150 ms. When the motor 8 becomes its open state, the motor 8 continues revolving through inertia.

Step SD9: Next, the control section 17 short-circuits the terminals of the motor 8 to provide its brake state. A period of time for the brake state is, for example, 100 ms. When the motor 8 becomes the brake state, the motor 8 is forced to stop its revolution. In the present example, a period of time Tms from a time when the motor 8 becomes open state to a time when its normal revolution is stopped as its brake state is 250 ms. Processing of the above-described steps SD1 through SD9 constitutes one cycle of normal revolution drive control.

Step SD10: The control section 17 opens the terminals of the motor 8 to provide the open state hereof. A period of time Tmo, for the open state is, for example, 150 ms.

Step SD11: To drive the motor 8 inversely, the control section 17 outputs the reverse revolution instruction signals RP2, RN2. When the normal revolution instruction signals RP2, RN2 are output from the control section 17, if the cap body 5 is closed normally and no overcurrent is detected, the reverse revolution drive signals P2, N2 are output from the logic IC 19.

Step SD12: When receiving the reverse revolution drive signals P2, N2, the motor drive circuit 15 drives the motor 8 in the inverse direction. With this, the motor 8 starts revolving in the inverse direction.

Step SD13: The control section 17 outputs the reverse revolution instruction signals RP2, RN2 to start driving the motor 8 inversely, and reads the current value signal MC output from the current detection circuit 16 after a period of the standby time T4 is elapsed in order not to decide an inrush current as an overcurrent mistakenly in a manner similar to that in the case of the normal direction driving.

Step SD14: When the control section 17 outputs the reverse revolution instruction signals RP2, RN2 to start driving the motor 8 inversely and the period of standby time T4 is elapsed, the control section 17 starts the timer to start clocking a period of reverse revolution drive time T6. In the present example, the period of reverse revolution drive time T6 is set to five seconds, which is the same as the normal revolution drive time T5.

Step SD15: During driving of the motor in revolution, the control section 17 conducts any overcurrent detection controls shown in FIG. 15, which will be described later, in accordance with a predetermined program.

Step SD16: The control section 17 decides whether the reverse revolution drive time T6 (=5 seconds) has elapsed.

Step SD17: When having decided that the period of reverse revolution drive time T6 has elapsed, the control section 17 first opens the terminals of the motor 8 to provide the open state thereof in order to stop its reverse revolution. The period of time for the open state is, for example, 150 ms. When the motor 8 becomes the open state, the motor 8 continues revolving through inertia.

Step SD18: Next, the control section 17 short-circuits the terminals of the motor 8 to provide its brake state. A period of time for brake state is, for example, 100 ms. When the motor 8 becomes its brake state, the motor 8 is forced to stop its revolution. In the present example, a period of time Tms from a time when the motor 8 is opened to a time when the motor 8 becomes brake state to stop its reverse revolution is set to 250 ms. Processing of the above-described steps SD10 through SD18 constitutes one cycle of reverse revolution drive control.

Then, until deciding at step SC6 of FIG. 11 that the period of overall drive time T3 has elapsed, the control section 17 repeats normal revolution and reverse revolution of the motor 8 for every 5 seconds in accordance with the flowchart shown in FIG. 12 as far as it does not detect an overcurrent.

As the motor 8 repeats the normal revolution and the reverse revolution, the crushing rotary blades described in FIGS. 4 and 5 repeat normal and reverse revolutions, thereby uniformly stirring and finely crushing garbage thrown into the crushing unit 6. This improves the crushing ability.

Further, in a case where a motor equipped with a brush is employed as the motor 8, the brush can be worn uniformly to elongate a life thereof as compared to a configuration in which the motor revolves only in one direction.

<Software Processing of Overcurrent Detection Control>

FIGS. 15 through 17 are flowcharts each for showing an example of software processing of the motor 8 at the time of overcurrent, which is followed by detailed description of overcurrent detection control on the motor 8.

Step SE1: when the control section 17 outputs the normal revolution instruction signals FP1, FN1 or the reverse revolution instruction signals RP2, RN2 to start driving the motor 8, it reads the current value signal MC out of the current detection circuit 16 as described with steps SD4 and SD13 of FIG. 12 after the period of standby time T4 has elapsed. Then, it decides whether a current flowing through the motor 8 is equal to or larger than the overcurrent threshold value.

Step SE2: When having detected a current not less than the overcurrent detection threshold value, the control section 17 integrates the current values and calculates an integrated average value.

In the crushing unit 6 described in FIGS. 4, 5, etc., in a condition where the crushing rotary blades can revolve in normal operations, a value of current which flows through the motor 8 is, for example, about 600 mA as shown in FIG. 13. Since the overcurrent detection threshold value is set to 1.5 A, the control section 17 does not detect an overcurrent normally.

In contrast, if the crushing rotary blades cannot revolve normally because, for example, hard kitchen garbage such as seashells is jammed between the crushing rotary blade and the crushing fixed blade or are supplied with an overload because the crushing rotary blades are locked due to jamming of an object which cannot be crushed such as a spoon, a large current flows through the motor 8. This causes a value of current that flows through the motor 8 to become equal to or at least the overcurrent detection threshold value as shown in FIG. 14.

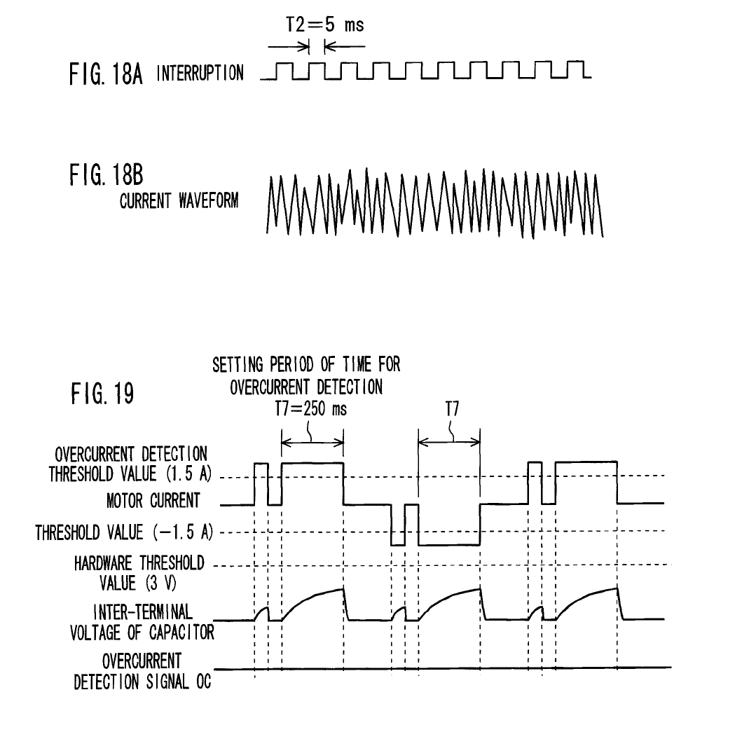

FIG. 18A is a waveform chart for showing an interruption timing at which an output of the current detection circuit 16 that detects a current flowing through the motor 8 is read and FIG. 18B is a schematic waveform chart of a current flowing through the motor 8.

As the motor 8 revolves, the current flowing through the motor 8 fluctuates as shown in FIG. 18B. Therefore, if a current not less than the overcurrent detection threshold value is detected, the current values are read and integrated for every period of predetermined interruption time T2 (=5 ms). Then, an average value of the integrated current values is calculated for every predetermined number of times of reading K2. In the present example, the number of times of reading K2 is set to, for example, 10.

Step SE3: The control section 17 decides whether an integrated average value of the current values read from the current detection circuit 16 is equal to or larger than the overcurrent detection threshold value.

Step SE4: If having decided at step SE3 that the integrated average value of the current values read from the current detection circuit 16 is not larger than the overcurrent detection threshold value, the control section 17 continues to go through the motor revolution control routine described in FIG. 12.

That is, as reading the current value signal MC output from the current detection circuit 16 and monitoring whether a value of current flowing through the motor 8 is equal to or larger than the overcurrent detection threshold value, the control section 17 continues driving the motor in the normal direction until the period of normal revolution drive time T5 elapses during normal revolution drive control of the motor 8 as far as no overcurrent is detected. Similarly, during reverse revolution drive control of the motor 8, it continues driving the motor inversely until the period of reverse revolution drive time T6 elapses.

Step SE5: If having decided at step SE3 that the integrated average value of the values of current read from the current detection circuit 16 is equal to or larger than the overcurrent detection threshold value, the control section 17 decides that an overcurrent is flowing and decides whether the period of overcurrent detection time has exceeded a predetermined period of overcurrent detection setting time T7. In the present example, the period of overcurrent detection setting time T7 is set to 250 ms. It is to be noted that unless the period of overcurrent detection time has exceeded the period of predetermined overcurrent detection setting time T7, the process continues to go along the motor revolution control routine described in FIG. 12. Even if an overcurrent is detected, with continuing revolution, hard objects etc. can be crushed to recover to a condition where the crushing rotary blades can revolve normally. Therefore, by setting the period of overcurrent detection setting time T7 and continuing its revolution, it is possible to retry crushing processing with suppressing an influence of an overload on the motor 8 etc.

Step SE6: When having decided that the period of overcurrent detection time has exceeded the period of overcurrent detection setting time T7 (=250 ms), the control section 17 adds the number of times of reverse revolution.

Step SE7: The control section 17 decides whether the number of times of reverse revolution is equal to or larger than a predetermined number of times of error decision K3. In the present example, the number of times of error decision K3 is set to 20.

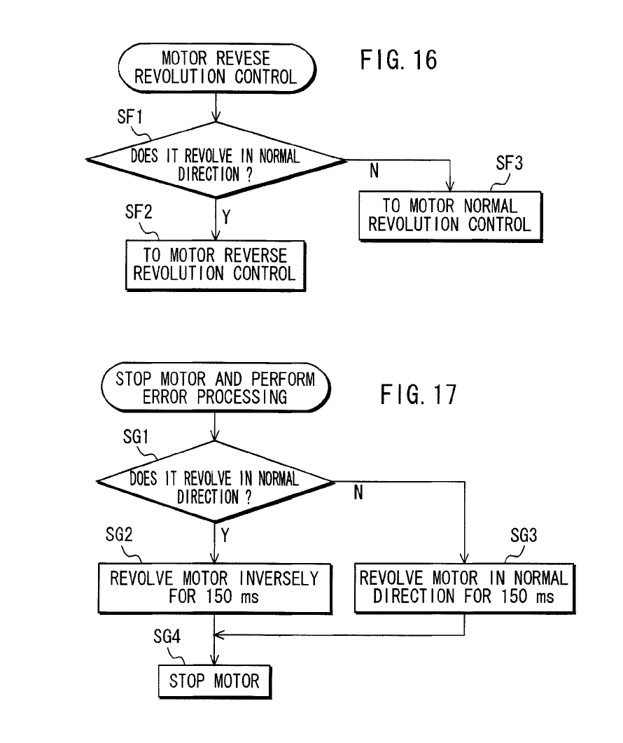

Step SE8: If having decided that the number of times of reverse revolution is less than the number of times of error decision K3 (=20), the control section 17 conducts reverse revolution control of the motor 8 as shown in FIG. 16.

Step SE9: If having decided that the number of times of reverse revolution is equal to or larger than the number of times of error decision K3, the control section 17 conducts error-processing control of the motor 8 as shown in FIG. 17.

Next, the reverse revolution control will be described with reference to FIG. 16 etc.

Step SF1: To conduct reverse revolution control on the motor 8, the control section 17 decides a revolution direction of the motor 8.

Step SF2: If having decided that the motor 8 is revolving in the normal direction, the control section 17 revolves inversely. That is, the control section 17 first makes the motor 8 set to its open state. A period of time for the open state is 150 ms as described above. When the motor 8 becomes its open state, the motor 8 continues revolving through inertia.

Next, the control section 17 makes the motor 8 set to its brake state. A period of time for the brake state is 100 ms as described above. When the motor 8 becomes its brake state, the motor 8 is forced to stop its revolution.

The control section 17 holds the motor 8 in the open state for 150 ms and then outputs the reverse revolution instruction signals RP2, RN2. This causes the motor 8 to start its reverse revolution.

Step SF3: If having decided that the motor 8 is revolving inversely, the control section 17 conducts normal revolution control. That is, as described above, after making the motor 8 set to its open state, the control section 17 makes it set to its brake state and set to its open state and then, outputs the normal revolution instruction signals FP1, FN1. This causes the motor 8 to start revolving in the normal direction.

In such a manner, by conducting reverse revolution control of the motor 8 upon detection of an overcurrent, the revolution direction of the crushing rotary blades described in FIGS. 4, 5, etc. is reversed to eliminate jamming etc. of objects to be crushed contributing to an occurrence of the overcurrent, thereby recovering the apparatus to a normal state thereof without it stopping because of an occurrence of an error.

It is to be noted that after the motor 8 revolves inversely upon detection of the overcurrent, the process continues to go along the motor revolution control routine described in FIG. 12 and, if an overcurrent is detected again, it performs the overcurrent detection control routine described with FIG. 15.

Next, the error-processing control on the motor 8 will be described with reference to FIG. 17 etc.

Step SG1: In error-processing control, to drive the motor 8 inversely for a short period of time, the control section 17 decides the revolving direction of the motor 8.

Step SG2: If having decided that the motor 8 is revolving in the normal direction, the control section 17 conducts reverse revolution control for a short period of time. That is, as described above, the control section 17 makes the motor 8 set to its open state, to its brake state, to its open state again, and then, outputs the reverse revolution instruction signals RP2, RN2. In the present example, a period of the reverse revolution drive time is set to 150 ms.

Step SG3: If having decided that the motor 8 is revolving inversely, the control section 17 conducts normal revolution control for a short period of time. That is, as described above, the control section 17 makes the motor 8 set to its open state, to its brake state, to its open state again, and then, outputs the normal revolution instruction signals FP1, FN1. In the present example, a period of the normal revolution drive time is set to 150 ms.

Step SG4: After conducting drive control on the motor 8 for a short period of time at step SG2 or SG3, the control section 17 conducts stop control on the motor 8. For example, the control section 17 first makes the motor 8 set to its open state. A period of time for the open state is 150 ms as described above. Next, the control section 17 makes the motor 8 set to its brake state. A period of time for the brake state is 100 ms as described above. Then, the process finishes with the motor 8 being held on its open state.

If the number of times of reverse revolution is not less than the number of times of error decision K3, an object that cannot be crushed such as a spoon may have been jammed so that the jamming cannot be eliminated even with reverse revolution drive control, thereby enables the motor 8 to stop in driving.

It is to be noted that in the stop processing of the motor 8 in a case where the number of times of reverse revolution is not less than the number of times of error decision K3, if the motor 8 is driven inversely for a short period of time, it is possible to prevent biting between the crushing rotary blades of the crushing unit 6 and the drive shaft 7a of the decelerating unit 7 as described in FIG. 2 etc., thereby facilitating detachment of the crushing unit 6 upon a occurrence of an error.

As described above, the value of current flowing through the motor 8 fluctuates, so that by deciding whether an overcurrent is flowing based on an integrated average value of current values read from the current detection circuit 16, a mistaken detection by the overcurrent can be avoided. This improves any overcurrent detection accuracy to avoid unnecessary reverse revolution control, thereby enabling reducing the crushing processing period of time.

Further, in a case where reverse revolution control is necessary due to application of any overload, this can be detected certainly, so that it is possible to prevent continuous application of the overload on the motor 8 or the crushing rotary blades to avoid damages of the motor 8 and the crushing blades, by eliminating jamming through reverse revolution control or by stopping the motor 8 in driving.

<Fail Safe Functions through Overcurrent Detection by Hardware>

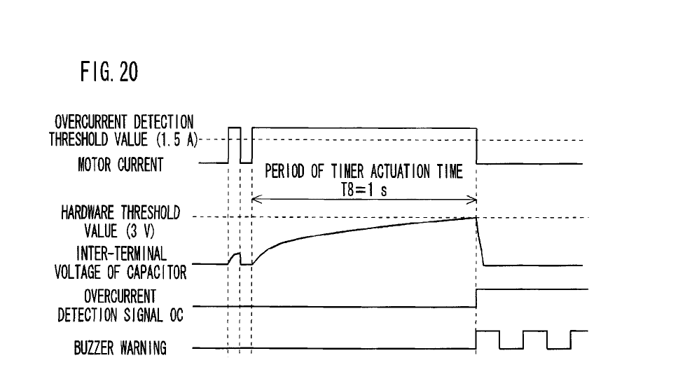

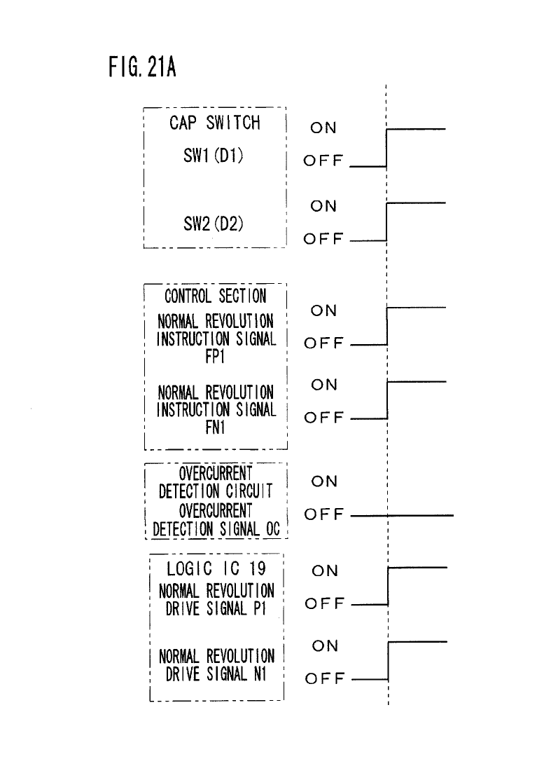

FIG. 19 is a timing chart in a case where an overcurrent is detected by software normally, and FIG. 20 is a timing chart in a case where no overcurrent is normally detected by the software, but the overcurrent is successfully detected by a hardware timer. It is to be noted that both FIGS. 19 and 20 show cases each where an overcurrent is flowing through the motor 8 and illustrate a waveform of a current flowing through the motor 8, a threshold value to detect an overcurrent flowing through the motor 8, a waveform of an inter-terminal voltage of the capacitor constituting the hardware timer in the current detection circuit 18, a threshold value of the inter-terminal voltage of the capacitor, and a waveform of the overcurrent detection signal OC output from the overcurrent detection circuit 18.

As described in FIG. 12, when the motor 8 is driven in revolution by software revolution control, the crushing rotary blades in the crushing unit 6 described in FIGS. 4, 5, etc. revolve to crush the garbage; however, if hard kitchen garbage such as seashells are jammed between the crushing rotary blade and the crushing fixed blade to thereby lock the crushing rotary blades, a large current flows through the motor 8.

In the present example, through the overcurrent detection control by software described with FIGS. 15 through 17, the control section 17 reads the current value signal MC out of the current detection circuit 16 and, if a current value not less than the overcurrent threshold value (1.5 A) is detected, it decides that an overcurrent is flowing.

The overcurrent detection circuit 18 is configured so as to charge the capacitor constituting the hardware timer circuit if a current not less than the overcurrent detection threshold value (1.5 A) set by the software flows.

If, then, the overcurrent continues to flow through the motor 8, the inter-terminal voltage of the capacitor rises; however, if the period of overcurrent detection time exceeds the period of overcurrent detection setting time T7 (=250 ms) through the overcurrent detection control by software described in flowcharts of FIGS. 15 through 17, as far as the control section 17 operates normally, the motor 8 is driven in reverse revolution control as shown in FIG. 15 etc. By driving in reverse revolution control on the motor 8, driving of the motor 8 stops once, thereby discharging the capacitor constituting the hardware timer circuit in the overcurrent detection circuit 18.

In the overcurrent detection circuit 18, if a overcurrent continues to flow through the motor 8, the inter-terminal voltage of the capacitor reaches a reference voltage (3V in the present example) during a period of timer actuation time T8 that is set on the basis of a time constant of the circuit, which period of timer actuation time T8 is set to, for example, 1 second, which is longer than the period of overcurrent detection setting time T7.

Therefore, even if an overcurrent flows through the motor 8, as far as the control section 17 operates normally, the motor 8 is controlled to be driven in reverse revolution before the inter-terminal voltage of the capacitor reaches the reference voltage, to discharge the capacitor as shown in FIG. 19, thereby preventing the overcurrent detection circuit 18 from outputting the overcurrent detection signal OC.

In contrast, if the control section 17 does not operate normally so that an overcurrent continues to flow through the motor 8 as shown in FIG. 20, in the overcurrent detection circuit 18, the inter-terminal voltage of the capacitor rises as shown in FIG. 20, and if the period of timer actuation time T8 elapses under this state, the inter-terminal voltage of the capacitor reaches the reference voltage (3V). Then, for example, an output of the hardware timer circuit is turned ON to operate the latch circuit, thereby continuing to output the overcurrent detection signal OC as shown in FIG. 20.

It is to be noted that the overcurrent detection signal OC is input to the control section 17 and, when having detected the overcurrent detection signal OC, the control section 17 sounds the buzzer 20 to give a warning as shown in FIG. 20. It then causes the buzzer 20 to continue sounding until its power switch is turned OFF and reset, to enable warning the user of an occurrence of an abnormality in the overcurrent detection control by software.

In such a manner, by enabling the overcurrent detection signal OC through the hardware timer by the overcurrent detection circuit 18 to be output, an overcurrent can be detected even if overcurrent detection by use of software cannot normally be performed owing to a failure of the control section 17. Further, as described later, it is possible to stop driving the motor 8 by using the logic IC 19, thereby preventing the motor 8 from being driven in a condition where it is overloaded continuously.

<Fail Safe Functions through Cap Open/Closed-State Detection by Hardware>

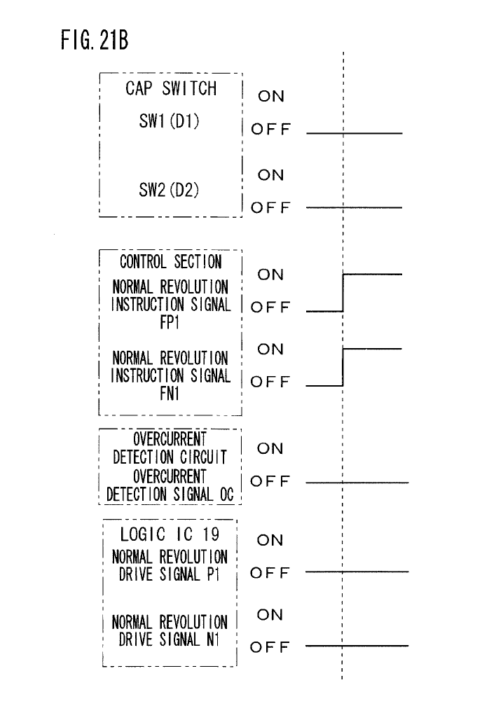

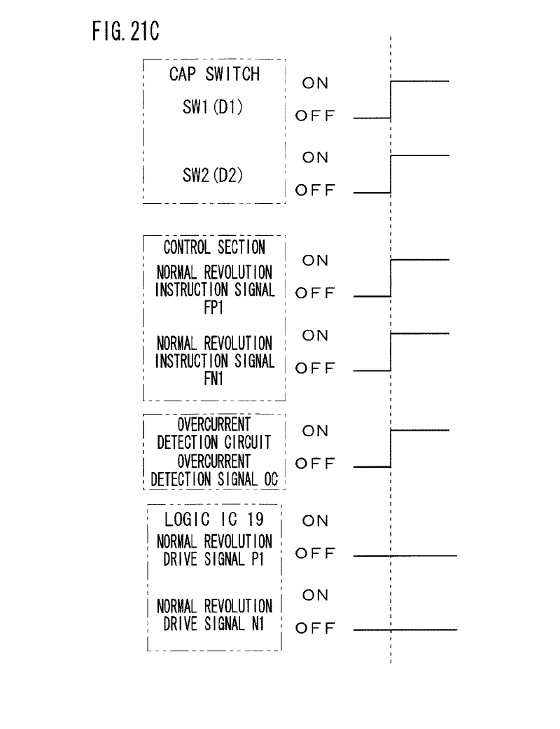

FIGS. 21A through 21C are timing charts for showing an open/closed state of the cap body 5 and motor control through detection of an overcurrent: FIG. 21A shows a state where the cap body 5 is closed normally; FIG. 21B shows a state where the cap body is open; and FIG. 21C shows a state where the overcurrent is detected.

If having decided that the cap body 5 is closed normally because the cap body 5 is mounted to the throwing opening 4 and locked under its closed condition, as described in the flowchart of FIG. 6, and the OPEN/CLOSE signal D1 output from the first cap switch 11a and the OPEN/CLOSE signal D2 output from the second cap switch 11b are turned ON, as described in the flowchart of FIG. 9, the control section 17 outputs the normal revolution instruction signals FP1, FN1 as shown in FIG. 21A.

In the logic IC 19, if the normal revolution instruction signal FP1 is turned ON and the OPEN/CLOSE signal D1 input from the first cap switch 11a is turned ON as well as the overcurrent detection signal OC input from the overcurrent detection circuit 18 is turned OFF, the normal revolution drive signal P1 is turned ON.

Further, in the logic IC 19, if the normal revolution instruction signal FP1 is turned ON and the OPEN/CLOSE signal D2 input from the second cap switch 11b is turned ON as well as the overcurrent detection signal OC input from the overcurrent detection circuit 18 is turned OFF, the normal revolution drive signal N1 is turned ON.

When the normal revolution drive signals P1, N1 is turned ON, the motor drive circuit 15 drives the motor 8 in normal direction. This causes the motor 8 to revolve in the normal direction.

In contrast, in the logic IC 19, even if the normal revolution instruction signal FP1 is turned ON, the normal revolution drive signal P1 remains OFF when the OPEN/CLOSE signal D1 is turned OFF, as shown in FIG. 21B. Similarly, even if the normal revolution instruction signal FN1 is turned ON, the normal revolution drive signal N1 remains OFF when the OPEN/CLOSE signal D2 is turned OFF.

Further, in the logic IC 19, even if the normal revolution instruction signal FP1 is turned ON and the OPEN/CLOSE signal D1 is turned ON, the normal revolution drive signal P1 remains OFF when the overcurrent detection signal OC is turned ON, as shown in FIG. 21C. Similarly, even if the normal revolution instruction signal FN1 is turned ON and the OPEN/CLOSE signal D2 is turned ON, the normal revolution drive signal N1 remains OFF when the overcurrent detection signal OC is turned ON.

In such a manner, only in a case where it is detected that the cap body 5 is closed hardware-wise and no overcurrent is detected, the normal revolution drive signals P1, N1 are output, so that if the cap body 5 is open, the logic IC 19 turns the drive signal OFF even if the control section 17 fails to output the normal revolution instruction signals FP1, FN1, thereby preventing the motor 8 from revolving.

Further, even if the overcurrent detection control by software cannot be conducted normally due to a failure of the control section 18, as described in FIG. 20, the overcurrent signal OC is detected through hardware detection, to turn the drive signal OFF by the logic IC 19 so that the motor 8 may not revolve. Further, during revolution of the motor 8, by turning the drive signal OFF, driving of the motor 8 stops.

It is to be noted that since the logic IC 19 utilizes the respective outputs of the first cap switch 11a and the second cap switch 11b, it is also possible to prevent a mistake in detection by the cap switch.

Although normal revolution driving has been exemplified in the description on FIGS. 21A through 21C because the motor 8 is first driven in normal revolution when the cap body 5 has been closed, the description holds the same also in the case of reverse revolution driving.

### INDUSTRIAL APPLICABILITY

The present invention can be installed in a kitchen etc. in a building to improve convenience in disposing of any garbage.

1-8. (canceled)

9. A garbage disposal containing crushing means that crushes an object to be crushed which is thrown into a throwing opening formed in a sink and drive means that rotationally drives the crushing means, wherein the garbage disposal comprises:
current detection means that detects a current flowing through the drive means; and
control means that monitors an output of the current detection means to decide whether or not an overcurrent is flowing and controls the drive means to revolve inversely, if having detected a current not less than a predetermined overcurrent detection threshold value.

10. The garbage disposal according to claim 9, wherein when driving of the drive means has started, the control means monitors the output of the current detection means to decide whether the overcurrent is flowing after a predetermined standby time elapses.

11. The garbage disposal according to claim 9, wherein the control means integrates detected current values as many as a predetermined number of times of reading after having detected a current not less than the overcurrent detection threshold value and, if an average value of the integrated ones is not less than the overcurrent detection threshold value, the control means controls the drive means to revolve inversely.

12. The garbage disposal according to claim 9, wherein the control means controls the drive means to revolve inversely if a period of time when a current not less than the overcurrent detection threshold value is detected reaches a predetermined period of overcurrent detection setting time.

13. The garbage disposal according to claim 12, wherein, if having detected no current equal to or larger than the overcurrent detection threshold value, the control means controls the drive means to revolve inversely for every constant period of time larger than the period of overcurrent detection setting time.

14. The garbage disposal according to claim 9, wherein the control means counts the number of times of reverse revolution of the drive means based on the overcurrent detection and stops driving of the drive means if the number of times reaches a predetermined number of times of the reverse revolution.

15. The garbage disposal according to claim 14, wherein, if the number of times of reverse revolution of the drive means based on the overcurrent detection reaches a predetermined number of times of reverse revolution, the control means stops driving of the drive means after conducting reverse revolution control for a short period of time.

16. The garbage disposal according to claim 9, wherein the crushing means contains a crushing rotary blade and a crushing fixed blade, which are put one upon another alternatively below the throwing opening, and the crushing rotary blade is driven rotationally by the drive means to crush an object to be crushed between the crushing rotary blade and the crushing fixed blade and run the object downward.
